(19) United States
(12) Patent Application Publication
(10) Pub. No.: US 2018/0139130 A1
(43) Pub. Date: May 17, 2018

(54) MULTI-LAYER NETWORK TOPOLOGY OPTIMIZATION

(71) Applicant: ARIA NETWORKS LIMITED, Somerset (GB)

(72) Inventors: Jonathan CRICKETT, Somerset (GB); Andrea CELLETTI, Somerset (GB)

(21) Appl. No.: 15/572,460

(22) PCT Filed: May 4, 2016
(86) PCT No.: PCT/GB2016/051276

§ 371 Date: Nov. 7, 2017

(30) Foreign Application Priority Data
May 7, 2015 (GB) 1507844.7

(51) Int. Cl. H04L 12/715; H04L 12/24

(52) U.S. Cl. CPC H04L 45/64; H04L 45/28; H04L 41/145

(57) ABSTRACT

Methods and systems for generating an optimized multi-layer network topology for a set of services. The method comprising generating one or more candidate service path vectors providing a single or multi-layer path for each service; identifying, for each candidate service path vector, a multi-layer topology from a set of network resources to support the paths provided in that candidate service path vector; generating a fitness value, for each candidate service path vector, the fitness value indicating the extent to which the candidate service path vector and the identified multi-layer topology for that candidate service path vector meet one or more constraints; and iteratively evolving the one or more service path vectors until a stop condition is satisfied.

### BACKGROUND

The operation of a data network is divided up into a vertical stack of layers. Each layer is responsible for a different function of the network and the nodes that perform that particular function are interconnected to form a layer-specific network. Each layer is connected to the layer above and the layer below so that information can be exchanged between layers. The most commonly used network layer model is the OSI model that comprises the following seven layers: (1) physical link layer, (2) data link layer, (3) network layer; (4) transport layer, (5) session layer, (6) presentation layer, and (7) application layer.

Network owners/operators typically want to design and build networks that are optimized for specific demands based on one or more criteria such as minimum number of links and/or minimum delay. However, for the optimization to be most effective the optimization must be over the multiple layers as a whole. In particular, network optimization must consider topological links within a layer and between layers. However, this becomes a complex problem for large networks.

The embodiments described below are provided by way of example only and are not limiting of implementations which solve any or all of the disadvantages of known network optimization systems.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Methods and systems for generating an optimum multi-layer network topology for a set of services. The method comprising generating one or more candidate service path vectors providing a single or multi-layer path through the network for each service; identifying, for each candidate service path vector, a multi-layer topology from a set of network resources to support the paths provided in that candidate service path vector; generating a fitness value, for each candidate service path vector, the fitness value indicating the extent to which the candidate service path vector and the identified multi-layer topology for the candidate service path vector meet one or more constraints; and iteratively evolving the one or more service path vectors until a stop condition is satisfied.

A first aspect provides a computer-implemented method of generating an optimized multi-layer network topology for a set of services, the method comprising, in a processing module: generating one or more candidate service path vectors, each candidate service path vector providing at least one single or multi-layer path for each service of the set of services; evaluating each of the candidate service path vectors comprising: identifying, for each candidate service path vector, a multi-layer topology from a set of network resources to support the paths provided in that candidate service path vector; generating, for each candidate service path vector, a fitness value, the fitness value indicating how well the candidate service path vector and the identified multi-layer topology for that candidate service path vector meet one or more constraints; determining whether a stopping condition is met based on the fitness values; in response to determining a stopping condition is not met, repeating the evaluating and determining; and in response to determining a stopping condition is met, outputting one of the candidate service path vectors and the identified multi-layer topology for that candidate service path vector.

A second aspect provides A system to determine an optimized multi-layer network topology for a set of services, the system comprising: a candidate generation module configured to generate one or more candidate service path vectors, each candidate service path vector providing at least one single or multi-layer path for each service of the set of services; a candidate evaluation module configured to repeatedly evaluate each of the candidate service path vectors by: identifying, for each candidate service path vector, a multi-layer topology from a set of network resources to support the paths provided in that candidate service path vector; generating, for each candidate service path vector, a fitness value, the fitness value indicating how well the candidate service path vector and the identified multi-layer topology for that candidate service path vector meet one or more constraints; and a stop condition module configured to repeatedly determine whether a stopping condition is met based on the fitness values and in response to determining a stopping condition is met, output one of the candidate service path vectors and the identified multi-layer topology for that candidate service path vector.

A third aspect provides a computer-implemented method of determining an optimized routing of a set of services through a network topology, the method comprising, in a processing module: generating one or more candidate service path vectors, each candidate service path vector providing at least one path through the network topology for each service of a plurality of services; evaluating each of the candidate service path vectors comprising generating, for each candidate service path vector, a fitness value, the fitness value indicating how well the candidate service path vector meets one or more constraints; determining whether a stopping condition is met based on the fitness values; in response to determining a stopping condition is not met, repeating the evaluating and determining; and in response to determining a stopping condition is met, outputting one of the candidate service path vectors.

The preferred features may be combined as appropriate, as would be apparent to a skilled person, and may be combined with any of the aspects of the invention.

### BRIEF DESCRIPTION OF THE DRAWINGS

Embodiments of the invention will be described, by way of example, with reference to the following drawings, in which:

FIG. 1 is a schematic diagram of an example set of network resources;

FIG. 2 is a schematic diagram of an example demand matrix;

FIG. 3 is a schematic diagram of an example network topology based on the network resources of FIG. 1;

FIG. 4 is block diagram of a system for generating an optimized multi-layer network topology;

FIG. 5 is a flow diagram of an example method for generating an optimized multi-layer network topology using the system of FIG. 4;

FIG. 6 is a flow diagram of an example method for generating a path table;

FIG. 7 is a schematic diagram illustrating generating the paths for a particular pair of source and destination nodes;

FIG. 8 is a schematic diagram of an example path table;

FIG. 9 is a flow diagram of an example method for generating a candidate service path vector;

FIG. 10 is a schematic diagram illustrating example candidate service path vectors;

FIG. 11 is a flow diagram of an example method of evaluating a candidate service path vector;

FIG. 12 is a schematic diagram of a candidate service path vector to be evaluated;

FIG. 13 is a schematic diagram illustrating the topology and associated bandwidth values for the candidate service path vector of FIG. 12;

FIG. 14 is a flow diagram of an example method for identifying the placement and number of layer 1 regeneration ports;

FIG. 15 is a schematic diagram illustrating the regeneration ports for the working paths of a particular candidate service path vector;

FIG. 16 is a schematic diagram illustrating the regeneration ports for the protection paths of a particular candidate service path vector;

FIG. 17 is a schematic diagram of an example set of constraints;

FIG. 18 is a flow diagram of an example method of evolving the candidate service path vector(s);

FIG. 19 is a schematic diagram illustrating mating candidate service path vectors;

FIG. 20 is a schematic diagram illustrating mutating candidate service path vectors;

FIG. 21 is a flow diagram of an example method of optimizing the routing of a set of services through a network topology; and

FIG. 22 is a block diagram of an example computing-based device.

Common reference numerals are used throughout the figures to indicate similar features.

### DETAILED DESCRIPTION

Embodiments of the present invention are described below by way of example only. These examples represent the best ways of putting the invention into practice that are currently known to the Applicant although they are not the only ways in which this could be achieved. The description sets forth the functions of the example and the sequence of steps for constructing and operating the example. However, the same or equivalent functions and sequences may be accomplished by different examples.

Described herein are methods and system for identifying an optimized multi-layer network topology to satisfy one or more service requirements based on one or more constraints. Each service requirement defines an amount of data or information transferred from one node of the network to another.

As described above, the operation of a data network is divided up into a vertical stack of layers where each layer is responsible for a different function of the network. The most commonly used network layer model is the OSI model that comprises the following seven layers: (1) physical link layer, (2) data link layer, (3) network layer; (4) transport layer, (5) session layer, (6) presentation layer, and (7) application layer. The example systems and methods described below will be described in reference multi-layer networks that comprise two layers—OSI Layer 1 (physical link layer) referred to herein as “layer 1” and OSI Layer 3 (network layer) referred to herein as “layer 3”, however it will be evident to a person of skill in the art that the methods and principles described herein may be applied to networks comprised of another combination of layers and/or based on a different layer model; and to networks with more than two layers.

When a network engineer is designing a new network he/she typically starts with a set of network resources that can be used to build the network and a set of service requirements (e.g. a definition of traffic to be transferred between nodes). The network engineer then wants to identify the optimum network topology (layer 1 and layer 3) from the set of network resources to satisfy the service requirements. Whether or not a network is optimum may be based on one or more criteria or constraints. Different criteria or constraints may be important to different network engineers. For example, one network engineer may wish to generate a topology that provides the lowest latency; another network engineer may wish to generate a topology that has a minimum number of hops for each service; and yet another network engineer may wish to generate a topology that has the least amount of equipment and/or links.

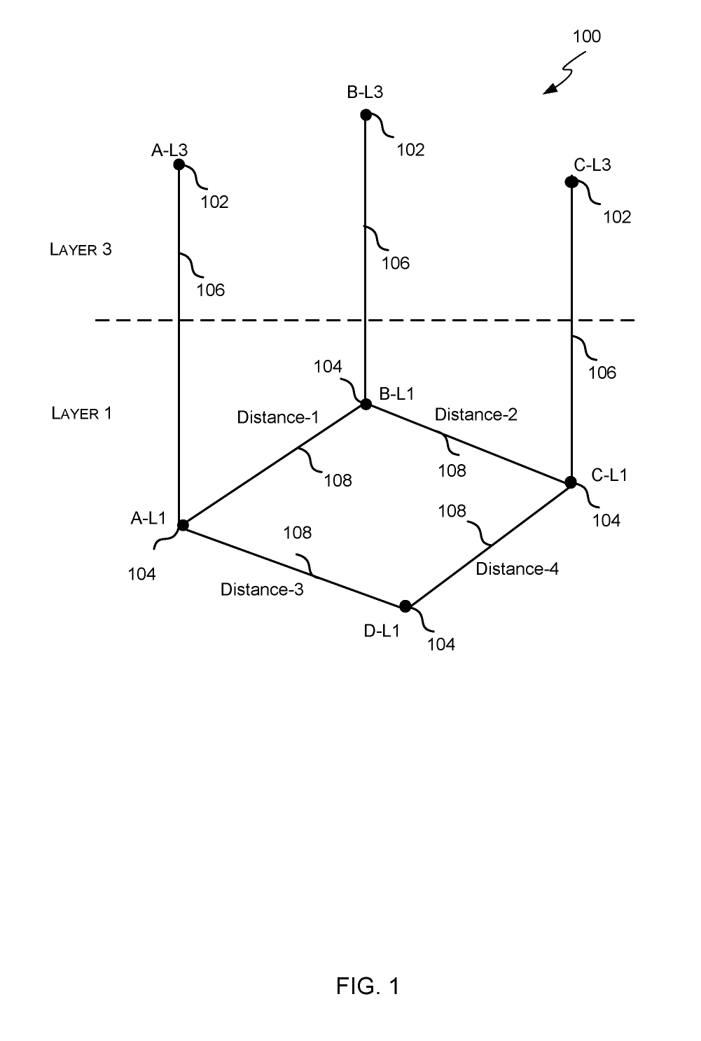

The set of network resources may comprise a list of the potential nodes in the network, their capability (layer 1 and/or layer 3), the potential layer 1 links between the layer 1 nodes, and the potential links between the layer 1 and layer 3 nodes. Reference is now made to FIG. 1 which shows an example set of network resources 100 which comprises a set of layer 3 nodes 102, a set of layer 1 nodes 104, the interconnections 106 between layer 1 and layer 3 nodes, the layer 1 links 108 connecting the layer 1 nodes 104, and the distance between layer 1 nodes 104.

The set of service requirements define the services to be run over the network. A service represents data that is sent from one node (e.g. the start or source node) in the network to another node in the network (e.g. the end or destination node). The set of service requirement may be represented by a demand matrix.

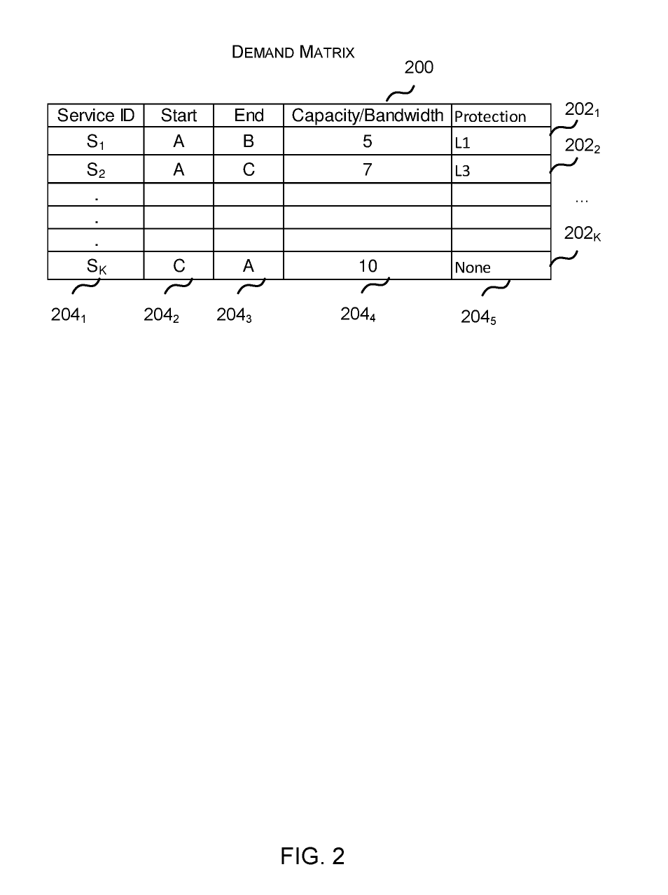

Reference is now made to FIG. 2 which illustrates an example demand matrix 200. The demand matrix 200 provides a list of services to be routed through the network and the requirements of the services. As described above a service represents traffic that is sent from one node (e.g. the start or source node) in a network to another (e.g. the end or destination node). The requirement or demand of a service is the amount of traffic that is sent from the start or source node to the end or destination node.

The demand matrix 200 of FIG. 2 comprises a number of rows 202₁-202_{K} and columns 204₁-204₅. Each row 202₁-202_{K} corresponds to a service that will run over the network. Accordingly, where there are K services there are K rows in the demand matrix 200. There may be none, one or more than one service associated with each combination of start and end nodes. In some cases each possible combination of start and end nodes in the network is associated with a single service. For example, where a network has four possible start/end nodes (A, B, C and D) there are 4″3=12 possible combinations of start and end nodes the demand matrix may have twelve rows. However, in other cases there may be more than one service associated with particular combinations of start and end nodes. For example, there may be two services that have start node A and end node B. In yet other cases, there may be no services associated with one or more combinations of start and end nodes. For example, there may be no services that have start node A and end node C.

Each column 204₁-204₅ provides information on the corresponding service. In the demand matrix 200 of FIG. 2, the first column 204₁ is used for the service identifier (e.g. S₁) which uniquely identifies the service. The second column 204₂ is used to identify the start node of the service, and the third column 204₃ is used to identify the end node of the service. In some cases nodes may be assigned a unique identifier which is used to identify the start and end nodes in the demand matrix 200. In the example shown in FIG. 2 each node is assigned a letter, but it will be evident to a person of skill in the art that this is an example only and other forms of unique identifiers may be used.

The fourth column 204₄ identifies the demand or requirement for the service (e.g. the amount of traffic that is sent from the specified start node to the specified end node). Each requirement may be represented, for example, by a capacity or bandwidth value (e.g. 10 Gbps).

The fifth column 204₅ identifies whether the service is protected. A protected service is one that requires a secondary or protection route or path between the start and end nodes to enable the service to be run in the event that the primary or working route or path fails. A service may be protected at multiple layers or just one layer. In some cases, a service must be protected at a certain layer to ensure a required level of service. For example, a layer 1 protection path may take a minute to restore traffic under a failure, whereas a layer 3 protection path may take only around 50 ms to restore traffic. Accordingly, where the network is being optimized over layer 3 and layer 1 the service may be protected at least at layer 1 (indicated by “L1” in FIG. 2) meaning that the secondary or protection path may be at layer 1 or above (e.g. layer 1, layer 3 or a combination of layers 1 and 3). Alternatively the service may be protected at least at layer 3 (indicated by “L3” in FIG. 2) meaning that the secondary or protection path may be at layer 3 or above (if there are higher layers); or may have no protection (indicated by “None” in FIG. 2).

It will be evident to a person of skill in the art that the demand matrix 200 of FIG. 2 is an example only and the demand matrix may comprise additional or alternative information; or the services and the requirements thereof may be represented in a different manner. For example, the demand matrix 200 may also specify other constraints that are specific to the service, such as, but not limited to the class of service.

Once the network engineer has the set of network resources 100 and the set of service requirements (e.g. demand matrix 200) the network engineer wants to identify the optimum multi-layer topology to satisfy the services.

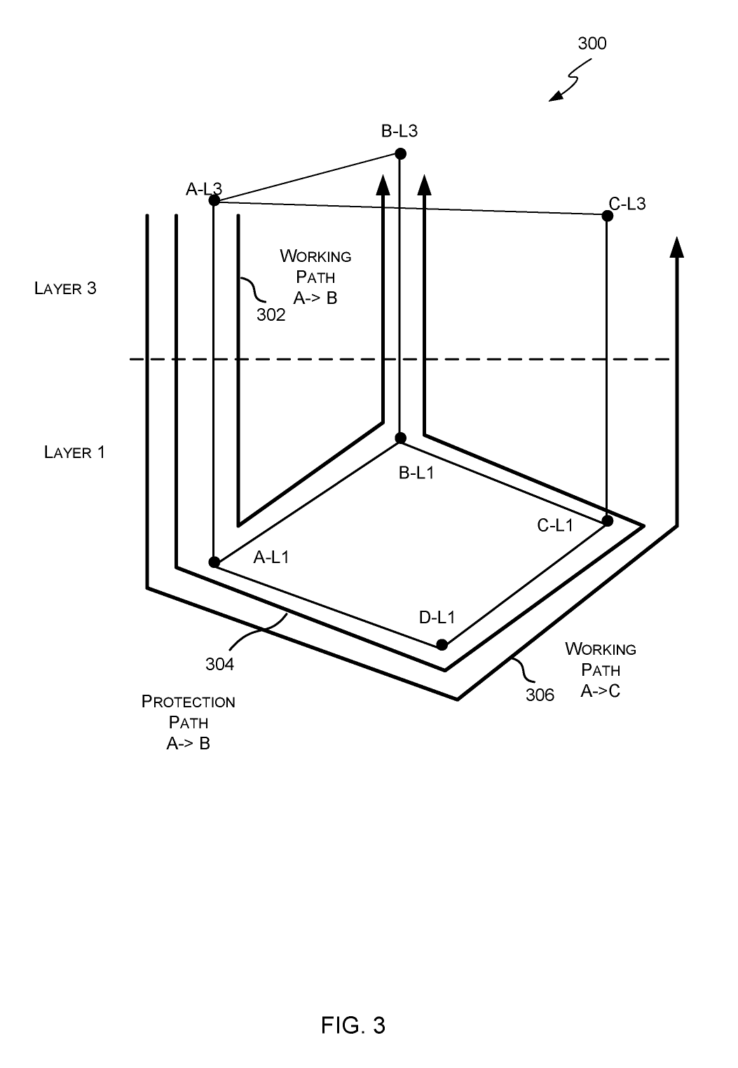

For example, reference is now made to FIG. 3 which illustrates an optimum layer 1 and layer 3 network topology 300 for the set of resources 100 of FIG. 1 and a demand matrix indicating a first service from A to B that is layer 1 protected and a second service from A to C that is not protected. In particular the optimum layer 1 and layer 3 network topology 100 comprises layer 3 links between A and B, and A and C. This allows the service from A to B to have a primary or working path 302 from A-L3, A-L1, B-L1 to B-L-3 and a secondary or protection path 304 from A-L3, A-L1, D-L1, C-L1, B-L1 to B-L3; and the service from A to C to have a primary or working path 306 from A-L3, A-L1, D-L1, C-L1 to C-L3.

Optimization of multiple layer of a network concurrently hasn't traditionally been done before on the basis that it has been deemed an intractable task. Generally each layer is optimized separately by a separate team or system and the requirements of higher layers are then passed to the team or system optimizing the lower layer(s). Accordingly there is no attempt at global optimization or optimization of multiple layers as whole. One disadvantage of optimizing the layers of a network individually is that optimizations are missed that come from protecting a service in part or in whole on a different layer.

Accordingly, described herein are global multi-layer optimization methods and systems. In particular described herein are methods and systems for identifying an optimized multi-layer network topology for a set of service requirements that comprises identifying one or more potential multi-layer routing solutions for the service requirements; identifying a multi-layer topology to support each of the potential routing solutions; iteratively evaluating and evolving the one or more potential routing solutions and associated multi-layer topologies until a stop condition has been met.

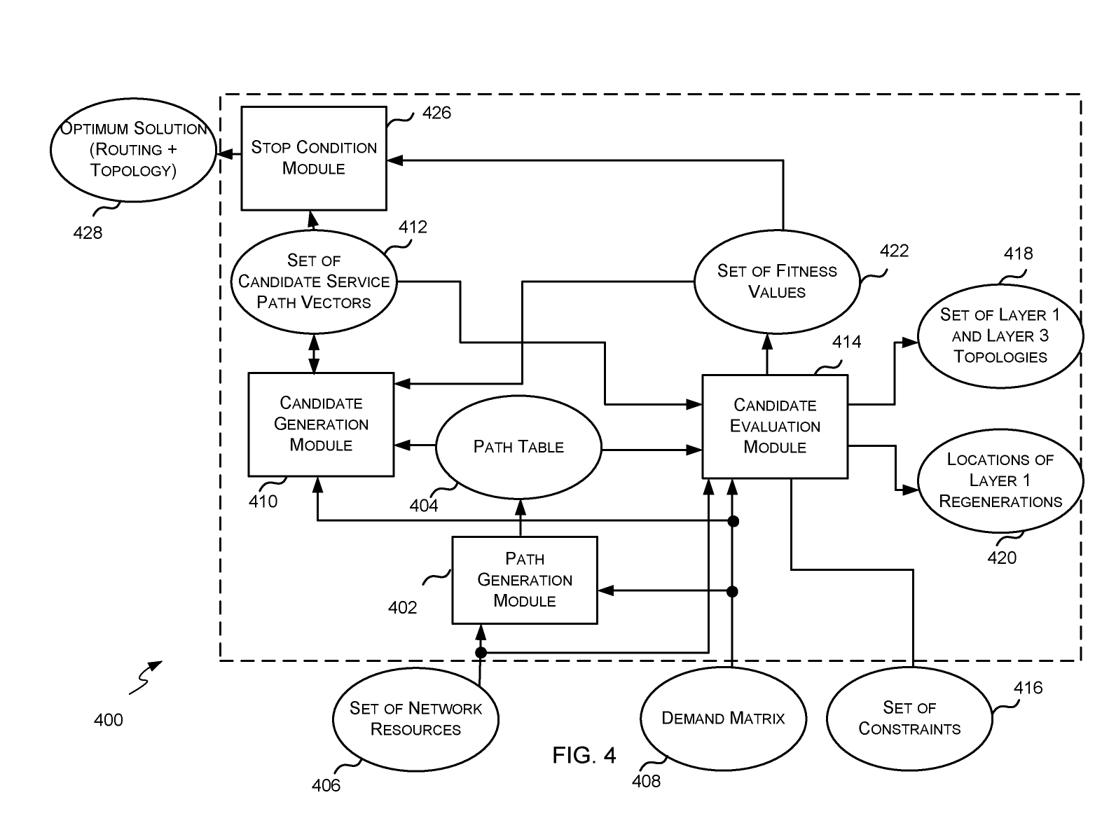

Reference is now made to FIG. 4 which illustrates an example system 400 for identifying an optimum multi-layer network topology for a set of service requirements based on one or more constraints. The system 400 is configured to generate one or more candidate service path vectors from the set of network resources and the demand matrix. Each candidate service path vector provides a possible path/route through the network for each of the services. From the paths/routing specified in a candidate service path vector a multi-layer topology to support the paths/routing can be generated to produce a candidate solution. The candidate service path vectors are then iteratively evaluated and evolved until a stopping condition has been met indicating the optimum solution has been identified. Since the quality of the solutions provided by the candidate service path vectors increases after each iteration, each iteration increases the probability that the set of candidate service path vectors comprises the optimum solution.

The system 400 comprises a path generation module 402 for generating a path table 404 from a set of network resources 406 and the demand matrix 408, the path table listing viable routes between the nodes of the network; a candidate generation module 410 for generating and iteratively evolving a set of candidate service path vectors 412 from the path table 404; a candidate evaluation module 414 for evaluating the set of candidate service path vectors 412 based on a set of constraints 416, the evaluation of a candidate service path vector comprising generating a layer 1 and layer 3 topology 418 that satisfies the paths/routing specified by the candidate service path vector, identifying the location of any layer 1 regenerations 420 and generating a fitness value 422 indicative of how well the solution provided by the candidate service path vector meets the set of constraints 416; and a stop condition module 426 for determining, based on the evaluation of the candidate service path vectors, when the iterative process can be stopped and then selecting the best candidate service path vector and outputting an optimum solution 428 based on the selected candidate service path vector.

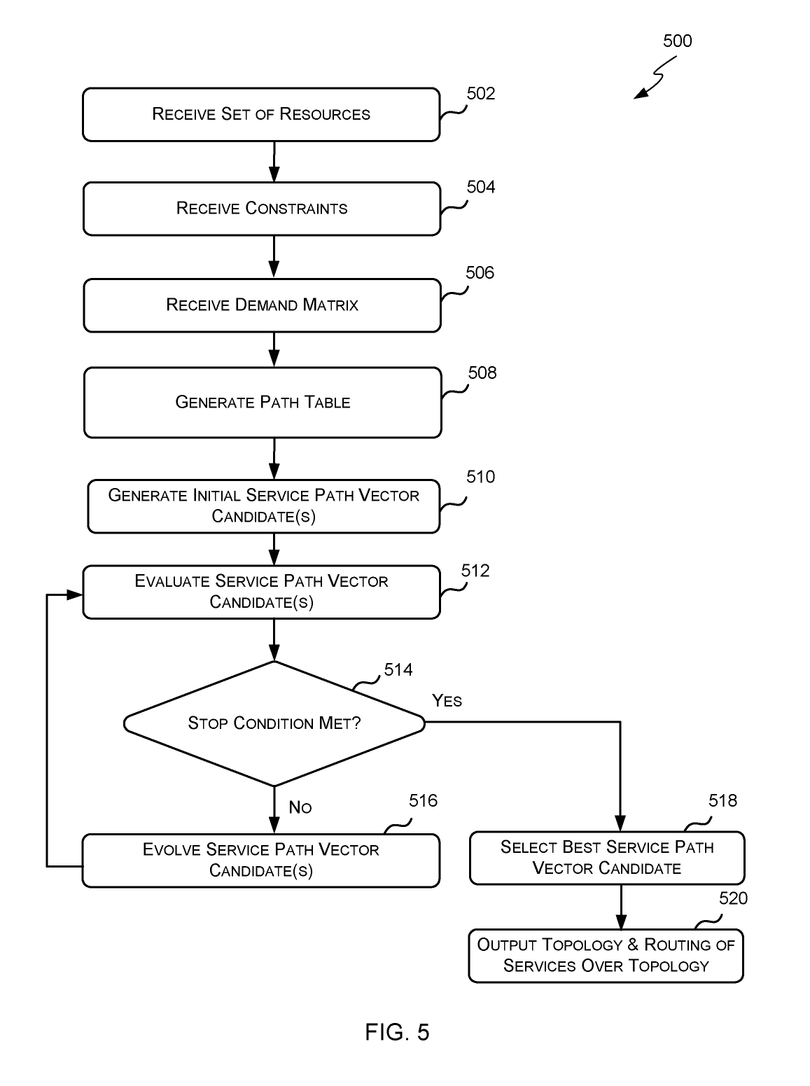

The operation of the system 400 will be described with reference to the method 500 of FIG. 5.

Reference is now made to FIG. 5 which illustrates a method 500 for identifying an optimum multi-layer network topology to satisfy a set of service requirements based on a set of constraints. The method 500 begins at block 502 where the system 400 receives the set of network resources 406. The set of network resources 406 comprises all of the potential components of the network and the possible configurations thereof which can be used to build the network topology. For example, as described above with respect to FIG. 1, the set of network resources 406 may comprise, a list of the potential nodes in the network, their capability (layer 1 and/or layer 3), the potential layer 1 links between the layer 1 nodes, and the potential links between the layer 1 and layer 3 nodes. The set of network resources 406 may also identify any links that are fixed or brownfield links.

The set of network resources may be generated by the user/owner of the network based on the options available to them to create their network. For example, the nodes may represent datacenters and the links between them may be the full list of options they have for linking two (or more) datacenters together. Such options may include, microwave links, satellite links, laying fiber, renting fiber, or renting capacity on a third party's fiber/microwave/satellite links. Once the set of network resources 406 have been received the method 500 proceeds to block 504.

At block 504, the system 400 receives the set of constraints 416. The set of constraints 416 includes one or more features (referred to as a constraint) that the candidate service path vectors are evaluated against. The set of constraints may be determined by the user/owner of the network based on the way in which they wish to optimize their network topology. For example, one user may wish to generate the topology that provides the lowest latency; another user may wish to achieve a topology with a minimum number of hops, and yet another user may wish to achieve a topology with the least amount of equipment and/or links.

The constraints may be classified as being either hard constraints or soft constraints. A hard constraint must be satisfied for the candidate service path vector to be a viable solution. Accordingly a candidate service path vector that does not satisfy a hard constraint will have a low fitness value (as described in more detail below). Example hard constraints include, but are not limited to, minimum bandwidth, maximum delay, and adjacency limit. In contrast, a soft constraint is preferred and ideally should be optimized, but is not required. Example soft constraints include, but are not limited to, minimize routing cost and minimize delay.

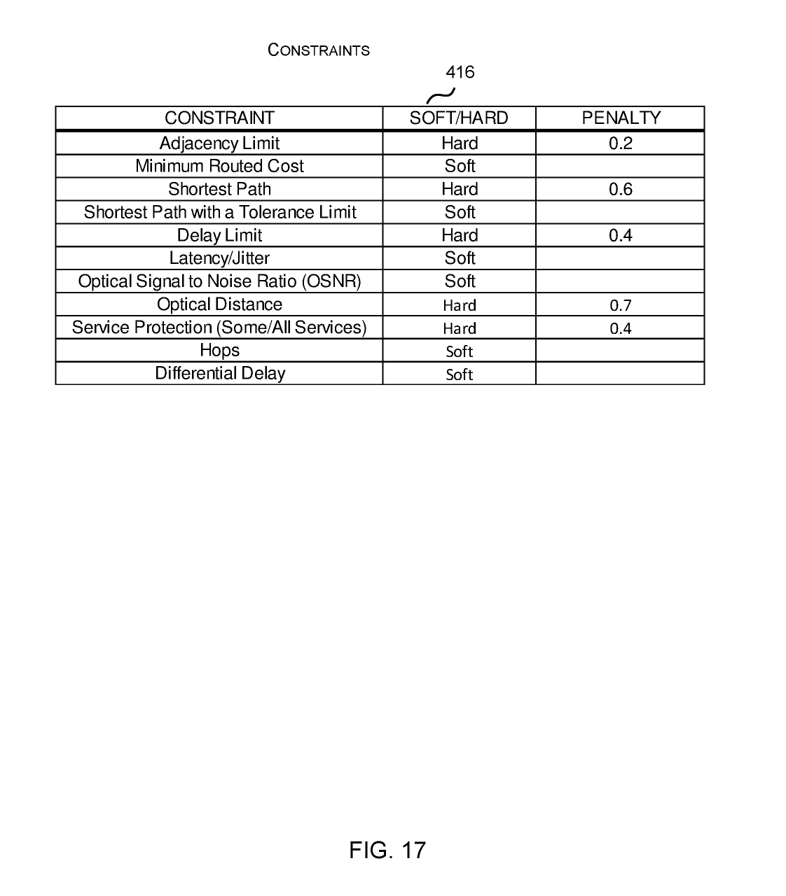

Not all constraints may be of equal importance, so in some cases the set of constraints 416 may comprise, in addition to a listing of the constraints themselves, weights indicating the relative importance of the constraints. Constraints will be described in more detail with reference to FIG. 17. Once the set of constraints have been received the method 500 proceeds to block 506.

At block 506, the system 400 receives the demand matrix 408. As described above, the demand matrix 408 provides a list of services to be routed through the network and the requirements of each service. A service represents traffic that is sent from one node (e.g. the start or source node) in a network to another (e.g. the end or destination node). The requirement/demand of a service is the amount of traffic that is sent from the start node to the end node. Each service may also be associated with one or more constraints. Once the demand matrix 408 has been received the method 500 proceeds to block 508.

It will be evident to a person of skill in the art that blocks 502 to 506 may be executed in any order or in parallel. For example, the system 400 may concurrently receive the set of network resources 406, the demand matrix 408 and the set of constraints 416.

At block 508, the path generation module 402 generates the path table 404 from the set of network resources 406 and the demand matrix 408. The path table 404 provides a list of the valid routes between each pair of source and destination nodes in the demand matrix 408. In one example the path generation module 402 may be configured to identify each unique pair of source and destination nodes in the demand matrix 408 and analyze the network resources 406 to identify the possible paths between the source and destination node. The path generation module 402 then stores the identified paths in the path table 404 with a unique identifier referred to as a “path ID”.

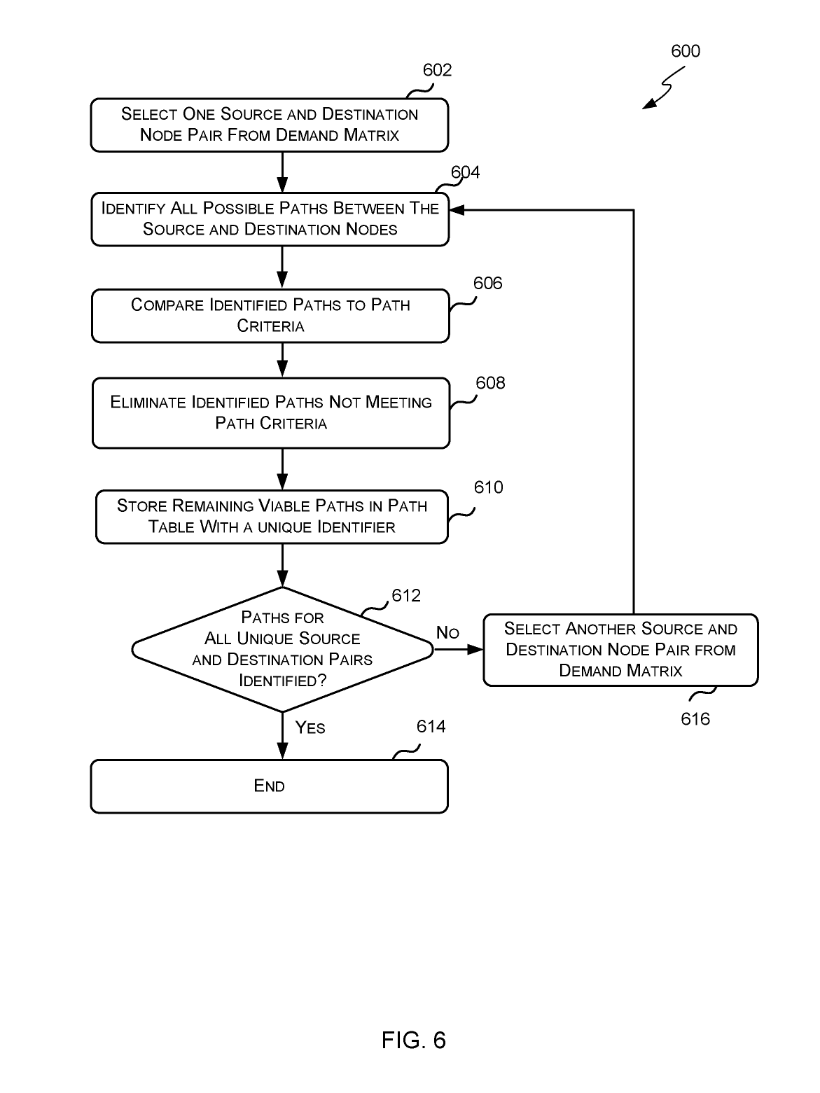

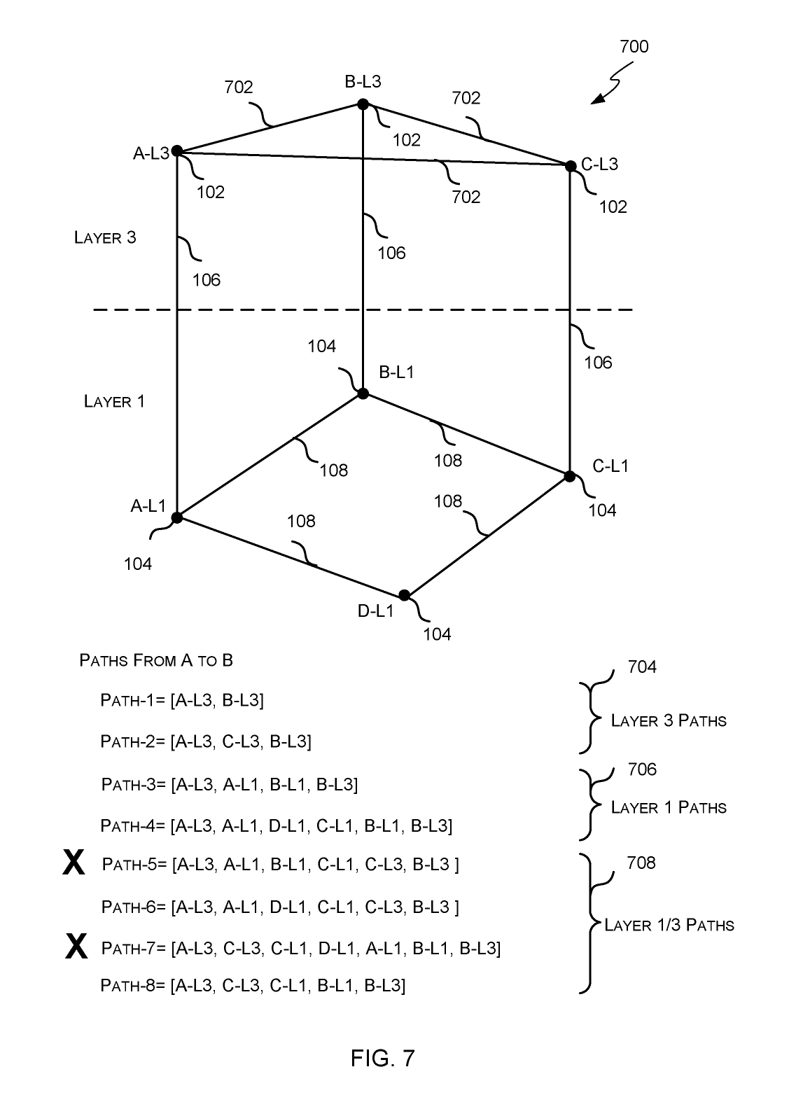

To reduce the number of paths in the path table 404, the path generation module 402 may be configured to eliminate those paths that do not meet predefined path criteria. For example, one path criteria may be that paths cannot exceed a certain number of hops. In this example, any path that exceeds the predefined number of hops may be eliminated and not stored in the path table 404. An example method for generating the path table 404 will be described with reference to FIGS. 6 and 7. Once the path generation module 402 has generated the path table 404 the method 500 proceeds to block 510.

At block 510, the candidate generation module 410 generates an initial set of M candidate service path vectors 412 from the demand matrix 408 and the path table 404 where M is any integer greater than or equal to one. Each candidate service path vector comprises an indexed list of path IDs which identify at least one path/route for each service in the demand matrix 408. Where a service is protected then there will be two path IDs in each candidate service path vector for that service, one for the primary or working path and one for the secondary or protection path.

The candidate generation module 410 may be configured to generate each candidate service path vector by randomly selecting, for each service, one of the paths in the path table 404 to get from the service source node to the service destination node. The path ID for the selected path is then placed in the candidate service path vector. For example, if the service runs from node D to node K and the path table has four entries for paths for getting from node D to node K then the candidate generation module 410 selects one of those four paths for that service and places the associated path ID in the candidate service path vector.

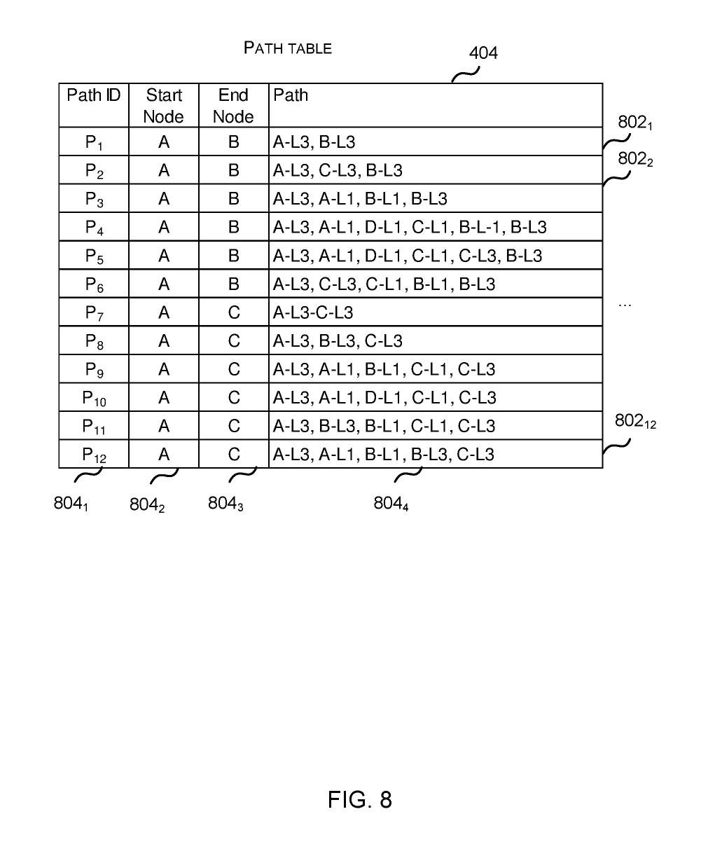

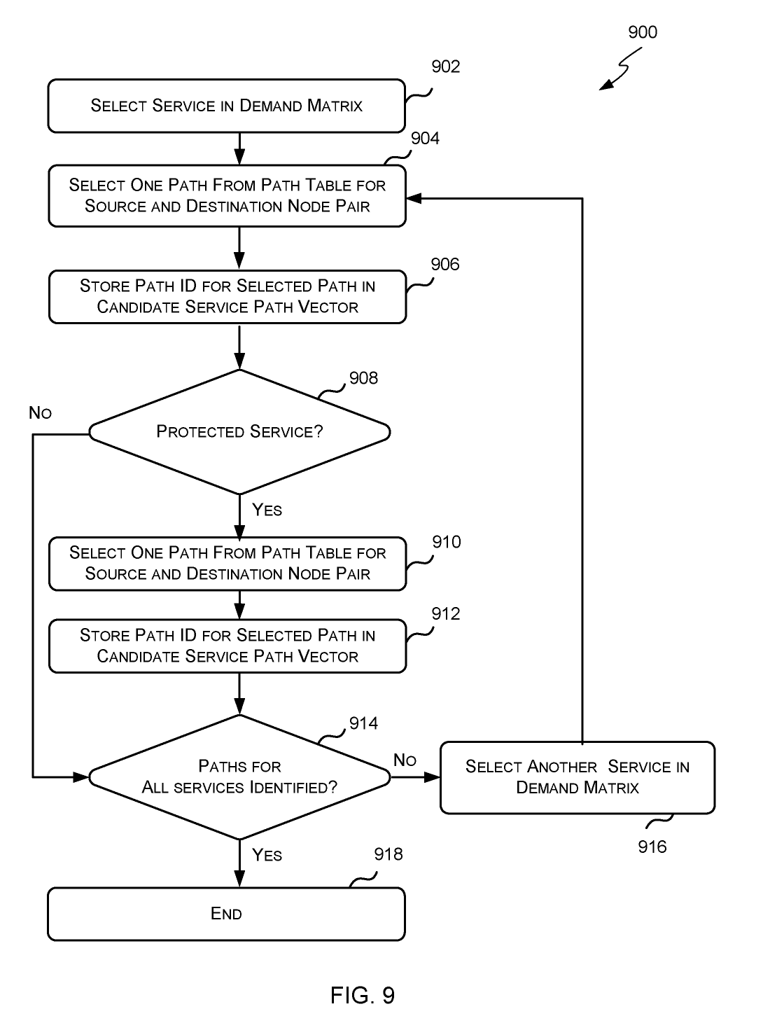

An example method for generating a candidate service path vector will be described with reference to FIGS. 8-9. Once the initial set of candidate service path vectors 412 has been generated the method 500 proceeds to block 512.

At block 512, the candidate evaluation module 414 evaluates each candidate service path vector against the set of constraints 416. Evaluation of a candidate service path vector may comprise determining the solution provided by the service path vector and then generating a fitness value 422 that is a quantitative measure of how well the solution provided by the candidate service path vector meets the set of constraints 416.

Each candidate service path vector specifies the path/route for each of the services in the demand matrix, however, it does not explicitly specify the layer 1 and 3 topology for supporting the specified routing. Accordingly the candidate evaluation module 414 may be configured to identify the layer 1 and layer 3 topology to support the routing specified in the candidate service path vector. This may include identifying the layer 1 and layer 3 links between the nodes, the bandwidth of those links, and the placement and number of layer 1 regeneration ports to support the specified routing. The solution provided by the candidate service path vector can be said to be the combination of the routing specified by the candidate service path vector and the topology for supporting the routing specified in the candidate service path vector.

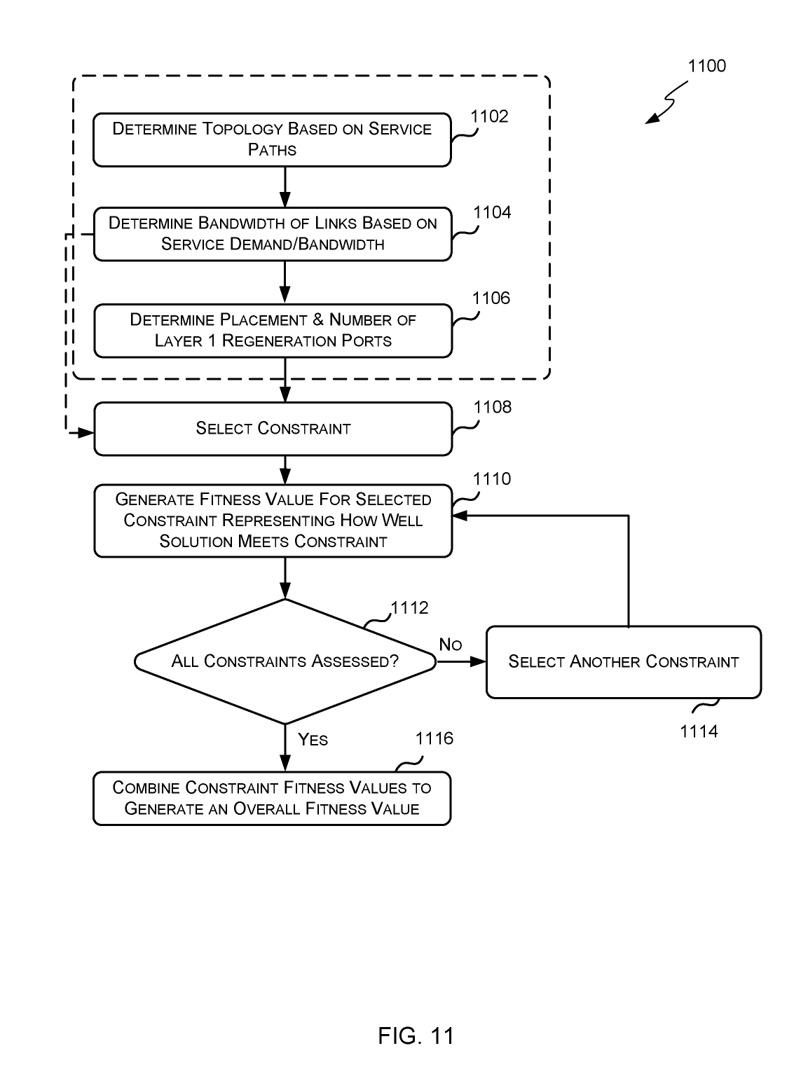

Once the solution provided by the candidate service path vector has been identified the solution is assessed or compared against the set of constraints to determine how well the solution meets the set of constraints. The assessment may be represented by a fitness value. In some cases generating a fitness value may comprise determining a sub-fitness value for each constraint where the sub-fitness value is a quantitative measure of how well the solution provided by the candidate service path vector meets the specific constraint and combining (e.g. summing or averaging) the sub-fitness values to generate the fitness value. In some cases all constraints may not be of equal importance so the final fitness value may be a weighted combination (e.g. sum or average) of sub-fitness values where the weights assigned to different sub-fitness values indicate the relative importance of their corresponding constraint. In some cases the fitness value is a number between 0 and 1 where 1 indicates an optimum candidate and 0 indicates a very poor candidate. An example method for evaluating a candidate service path vector will be described with reference to FIGS. 11-16.

The candidate service path vectors may be evaluated (e.g. solution identified and assigned a fitness value) serially (e.g. one at a time) or in parallel. For example, in some cases the candidate service path vectors may be evaluated in parallel.

Once the set of candidate service path vectors 412 have been evaluated, the method 500 proceeds to block 514

At block 514, the stop condition module 426 determines whether at least one stop condition has been met. The stop condition(s) may be, for example, if the best fitness value in the set of fitness values has not improved or changed after a predetermined number, R, of iterations. It will be evident to a person of skill in the art that this is an example only and other stop conditions may be used.

If the stop condition module 426 determines that none of the stop conditions have been met then the method 500 proceeds to block 516. If, however, the stop condition module 426 determines that at least one stop condition has been met then the method 500 proceeds to block 518.

At block 516, the candidate generation module 410 updates or evolves the set of candidate service path vectors in an attempt to increase the quality of the candidate service path vectors in the set. In particular, it is very unlikely that the initial set of candidate service path vectors comprises the optimum solution therefore the set of candidate service path vectors is evolved to pull the candidate service path vectors closer to the optimum solution.

In some cases evolving the set of candidate service path vectors comprises selecting one or more of the candidate service path vectors from the set of candidate service path vectors, generating one or more new candidate service path vectors from the selected candidate service path vectors (e.g. via mutation, mating (e.g. crossover) and/or a combination thereof) and replacing some of the candidate service path vectors in the set with the new candidate service path vectors. In some cases the new candidate service path vectors only replace candidate service path vectors in the set if the new candidate service path vectors are better (e.g. based on a fitness value) than candidate service path vectors in the set. In other cases the worst candidate (e.g. based on fitness values) is retained in the set of candidate service path vectors to preserve diversity. Deciding to retain the worse candidate service path vector is driven by a probability determined by the fitness of the candidate. In yet other cases the candidate service path vectors that are replaced by the new candidate service path vectors may be randomly selected from the set of candidate service path vectors.

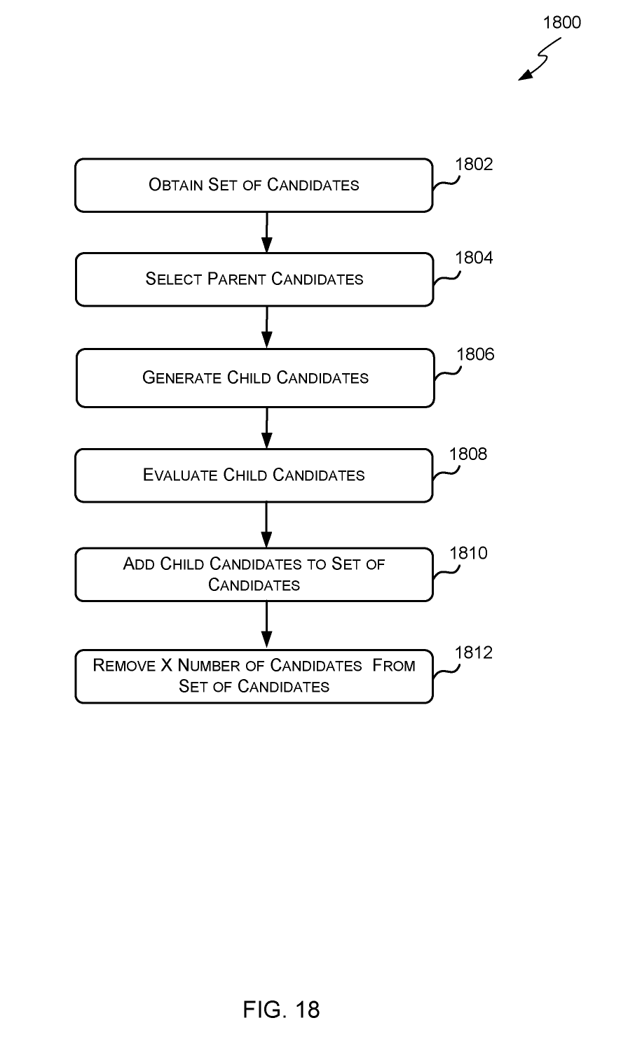

For example, in some cases the candidate generation module 410 is configured to select one or more parent candidate service path vectors from the set of candidate service path vectors. The parent candidate service path vector(s) may be the candidates with the best fitness values or the parent candidate service path vectors may be selected in another manner (e.g. they may be randomly selected). The candidate generation module 410 then generates one or more child candidate service path vectors from the parent candidate service path vector(s) using known techniques such as mating, mutation, or a combination thereof. The candidate generation module 410 then adds the child candidate service path vectors to the set of candidate service path vectors. An example method for updating or evolving the set of candidate service path vectors is described with reference to FIGS. 18 to 20.

The method 500 then proceeds back to block 512 where the candidate evaluation module 414 evaluates (e.g. assigns a fitness value to) each of the child candidate service path vectors. The candidate evaluation module 414 then updates the set of candidate service path vectors to include M candidate service path vectors where M is the number of candidate service path vectors initially generated in block 510. In some cases the best M candidate service path vectors (e.g. based on the fitness values) are selected. In other cases M candidate service path vectors are randomly selected. This process of evolving the set of candidate service path vectors is repeated until a stop condition is satisfied in block 514.

At block 518, once a stop condition has been met, the stop condition module 426 selects the best candidate service path vector (e.g. the candidate service path vector with the best fitness value). Once the best candidate service path vector has been selected the method 500 proceeds to block 520. At block 520 the solution (e.g. routing and topology) provided by the selected/best candidate service path vector is identified and output as the optimum solution for the service requirements based on the constraint(s).

Reference is now made to FIG. 6 which illustrates an example method 600 which may be executed by the path generation module 402 to generate the path table 404. As described above the path table 404 comprises a list of the possible routes through the network for each source and destination pair in the demand matrix 408. The method 600 begins at block 602 where the path generation module 402 selects one source and destination node pair from the demand matrix 408. Once a source and destination node pair has been selected the method proceeds to block 604.

At block 604, the path generation module 402 analyzes the set of network resources 406 to identify all the possible paths/routes through the network for each layer and for each combination of layers from the source node to the destination node. In particular, where the network is optimized over layer 1 and layer 3, the path generation module identifies all layer 1 paths/routes through the network, all layer 3 paths/routes through the network and all layer 1/layer 3 combination paths/routes. For example, where the source node is A and the destination node is B then the path generation module 402 analyses the set of network resources 406 to identify the layer 1 paths/routes from A to B, the layer 3 paths/routes from A to B and the layer 1/layer 3 combination paths/routes between A and B.

Reference is now made to FIG. 7 which illustrates analyzing the set of network resources 406 to identify all the possible layer 3, layer 1 and layer 1/layer 3 combination paths/routes between node A and node B. In the example of FIG. 7 the set of network resources 406 are the set of network resources 100 shown in FIG. 1. Although the set of network resources 100 includes only layer 1 links (i.e. links between layer 1 nodes) it is presumed that there there could be a layer 3 link between every combination of layer 3 nodes. Accordingly the first step in the analysis is generating a superset layer 3 topology 700 that comprises layer 3 links between all layer 3 nodes. For example, if there are three layer 3 nodes A, B and C then a layer 3 topology 700 is generated that comprises layer 3 links 702 between nodes A and B, B and C, and A and C.

Once the superset layer 3 topology has been generated, then the complete layer 1 and layer 3 topology is analyzed to identify the layer 3 paths 704, layer 1 paths 706 and layer 1/layer 3 combination paths 708 between the source and destination nodes. In the example if FIG. 7, where A and B are the source and destination nodes respectively the layer 3 paths comprises the following:
Path-1=[A-L3, B-L3]
Path-2=[A-L3, C-L3, B-L3]

the layer 1 paths comprise the following:
Path-3=[A-L3, A-L1, B-L1, B-L3]
Path-4=[A-L3, A-L1, D-L1, C-L1, B-L1, B-L3]

and the layer 1/layer 3 combination paths comprise the following:
Path-5=[A-L3, A-L1, B-L1, C-L1, C-L3, B-L3]
Path-6=[A-L3, A-L1, D-L1, C-L1, C-L3, B-L3]
Path-7=[A-L3, C-L3, C-L1, D-L1, A-L1, B-L1, B-L3]
Path-8=[A-L3, C-L3, C-L1, B-L1, B-L3]

In the example of FIG. 7, the paths are represented by a series of node identifiers, however, in other embodiments the paths may be represented in a different manner. For example, in some cases the links may be assigned unique identifiers and the paths may be represented by a series of link identifiers.

Referring back to FIG. 6, once the layer 3, layer 1 and layer 1/layer 3 combination paths have been identified the method 600 proceeds to block 606.

At block 606, the path generation module 402 compares the paths generated in block 604 against a set of path criteria to determine whether each of the paths is a viable path. The path criteria may be specified by the network designer and/or network owner and may include any feature by which the path may be assessed. Path criteria may include, but are not limited to, one or more of: number of hops, routing metric (e.g. IGP (Interior Gateway Protocol) metric), delay, and double use of a link.

Once the paths have been compared against the path criteria, the method proceeds to block 608 where the path generation module 402 eliminates any path not meeting the path criteria from the list of viable paths. For example, if one of the path criteria is that a link cannot be used more than once in a path (i.e. double use of a link) then Path-5 and Path-7 of FIG. 7 would be eliminated from the list of viable paths between A and B since both of these paths require traversal of the same layer 1 link twice. Specifically, Path-5 requires traversal of the links between B-L1 and C-L1 twice and Path-7 requires traversal of the links between C-L1 and D-L1, and D-L1 and A-L1 twice.

Eliminating the non-viable routes at this stage significantly reduces the amount of storage required for the path table. For example, in large networks there can be millions of paths and thus eliminating even 10% of the paths provides a significant saving in terms of memory and/or storage and computation effort allowing the optimum solution to be identified in hours or minutes instead of weeks, months or years. Once the paths that do not meet the path criteria are eliminated the method 600 proceeds to block 610.

At block 610, the path generation module 402 stores the remaining viable paths in a path table 404 where each path is assigned a unique identifier. Reference is now made to FIG. 8 which illustrates an example path table 404. The path table 404 comprises a number of rows 802₁ to 802₁₂ and columns 804₁ to 804₄. Each row 802₁ to 802₁₂ describes a viable path for a particular source and destination node pair and each column provides information about the particular path. In the example, of FIG. 8 the first column 804₁ identifies the unique path ID for the path, the second column 804₂ identifies the start node, the third column 804₃ identifies the end or destination node, and the fourth column 804₄ identifies the path. In the example of FIG. 8 the nodes in the network are uniquely identified by a letter, but it will be evident to a person of skill in the art that other unique identifiers, such as numbers or a combination of letters and numbers may be used. Further, in the example of FIG. 8 the path is identified by an ordered list of layer 1 and/or layer 3 nodes, but, as described above the path may be represented in a different manner. For example, the path may be represented by an ordered list of links.

It will be evident to a person of skill in the art that the path table 404 of FIG. 8 is an example only and the path table 404 may take another form and/or comprise different and/or additional information.

Referring back to FIG. 6, once the viable paths have been stored in the path table 404, the method 600 proceeds to block 612 where the path generation module 402 determines whether viable paths have been identified for all unique source and destination node pairs. If so, the method ends 614. If, however, there is at least one source and destination node pair for which the viable paths have not been identified then the method 600 proceeds to block 616 where one of the source and destination pairs for which viable paths have not been identified is selected. The method is then repeated until viable paths for all unique source and destination node pairs have been identified and stored in the path table 404.

While method 600 of FIG. 6 shows that block 604 to 610 are performed serially for each source and destination node pair (e.g. the paths for a particular source and destination node pair are identified and analyzed before the paths for another source and destination node pair are identified and analyzed), in other examples blocks 604 to 610 may be performed in parallel for multiple source and destination pairs. For example, the paths for two pairs of source and destination node pairs may be identified and analyzed in parallel.

Similarly, while method 600 of FIG. 6 shows that all the possible paths between the source and destination nodes are identified (block 604) and then the identified paths are compared to the criteria and eliminated as required (blocks 606 and 608), in other examples each path may be compared to the criteria as it is being identified. This allows paths to be eliminated as soon as they cease to meet all the criteria (e.g. exceed a hop count). This may increase efficiency in generating the path table as time is not wasted completing invalid (or not viable) paths nor or resources wasted in storing (even temporarily) invalid (or not viable) paths.

Reference is now made to FIG. 9 which illustrates a method 900 which may be executed by the candidate generation module 410 for generating a candidate service path vector. As described above, a candidate service path vector provides a candidate path through the network for each service and each protected service in the demand matrix 408. In some examples each candidate service path vector comprises an ordered list of path IDs which is indexed by services and protected services so that the candidate service path vector comprises a path ID for each service and each protected service.

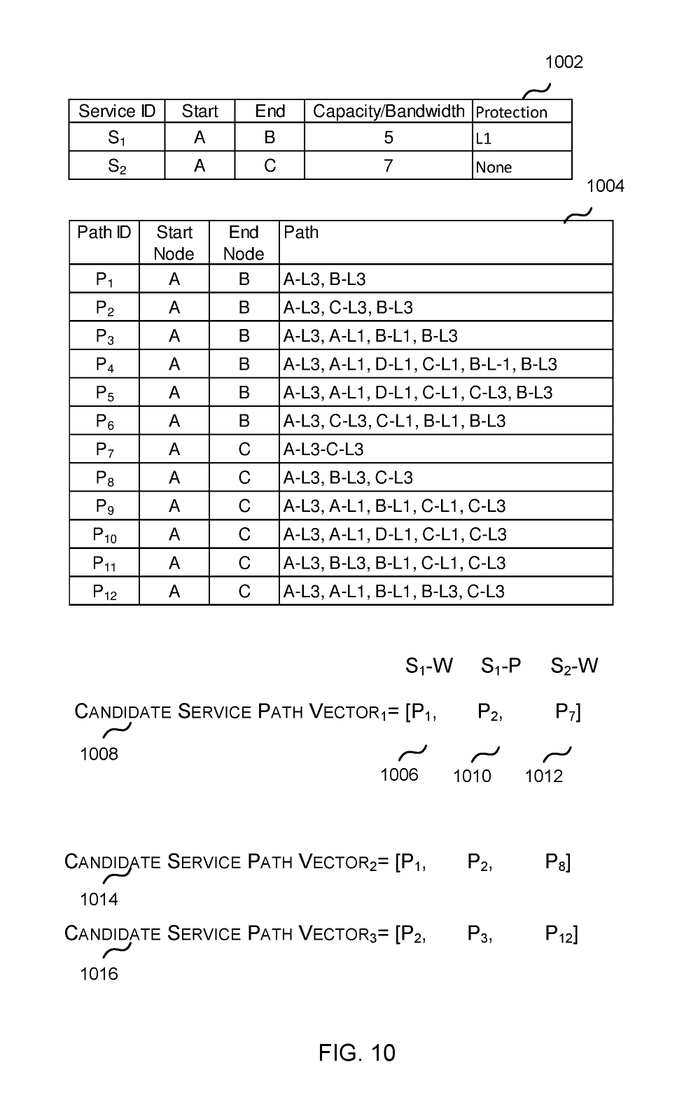

The method 900 begins at block 902 where the candidate generation module 410 selects a service in the demand matrix 408. Reference is made to FIG. 10 which illustrates an example demand matrix 1002 and path table 1004. The example demand matrix 1002 comprises two services S₁ and S₂. Accordingly, at block 902 the first service S₁ or the second service S₂ may be selected. Referring back to FIG. 9, once a service (e.g. S₁ or S₂) from the demand matrix 408, 1002 has been selected, the method 900 proceeds to block 904.

At block 904, the candidate generation module 410 selects one path from the path table 404 for the source and destination node pair of the selected service (e.g. S₁ or S₂) to be the primary or working path of the service. Referring back to FIG. 10, if the first service S₁ is selected in block 902 then the source and destination nodes are A and B respectively and a path in path table 1004 with source node A and destination node B is selected. In particular, the path table 1004 of FIG. 10 has six paths P₁ to P₆ for source node A and destination node B therefore in block 904 one of paths P₁ to P₆ is selected as the primary or working path for S₁. In some examples one path with matching source and destination nodes is randomly selected. In other examples, other criteria may be used to select the path. For example, if the path is the working path then only a layer 3 path may be selected. Referring back to FIG. 9, once a path has been selected for the source and destination node pair the method 900 proceeds to block 906.

At block 906, the candidate generation module 410 inserts the path ID for the selected path in the appropriate element of the candidate service path vector. In particular, each element of a candidate service path vector corresponds to either the working or primary path for a service, or a secondary or protection path for a service (if the service is protected). Since in block 904 a primary or working path has been identified for the selected service then the path ID of the selected service is inserted into the element of the candidate path vector corresponding to the primary or working path for the selected service.

Referring back to the example of FIG. 10, if S₁ was the selected service in block 902 and P₁ was the selected path for the working or primary path in block 904 then in block 906 P₁ is inserted in the first element 1006 of the first candidate service path vector 1008.

Referring back to FIG. 9, once the path ID of the selected path has been inserted into the appropriate element of the candidate service path vector then the method 900 proceeds to block 908.

At block 908, the candidate generation module 410 determines whether the selected service is a protected service (either layer 1 or layer 3). If the service is not protected then the method proceeds to block 914. If however, the service is protected (either layer 1 or layer 3) then the method proceeds to block 910 where another path from the path table 404 for the source and destination node pair is selected for the working or secondary path for the selected service; and at block 912 the selected path ID is inserted in the element of the candidate service path vector corresponding to the secondary or protection path for the selected service.

For example, referring back to FIG. 10 if S₁ was the selected service in block 902, since it is a protected service then at block 910 a second path for source node A and destination node B is selected (e.g. P₂) for the secondary or protection path. The path ID (P₂) of the selected path and then inserted in the second element 1010 of the first candidate service path vector 1008.

Referring back to FIG. 9, once the path ID of the selected service is inserted in the candidate service path vector the method 900 proceeds to block 914.

At block 914, the candidate generation module 410 determines whether paths for all services in the demand matrix 408 have been identified. If it has been determined that paths for all the services in the demand matrix 408 have not been selected and stored in the candidate service path vector then the method proceeds to block 916. At block 916 one of the services for which paths have not been selected and stored in the candidate service path vector is selected and the method repeats until paths for all services have been selected and stored in the candidate service path vector. Then the method 900 ends 918.

The generated candidate service path vector (e.g. candidate service path vector 1008) then forms part of the initial set of candidate service path vectors. The set of candidate service path vectors may have only a single candidate service path vector or the method 900 may be repeated to create a plurality of candidate service path vectors (e.g. candidate service path vectors 1014 and 1016).

Reference is now made to FIG. 11 which illustrates a method 1100 which may be executed by the candidate evaluation module 414 for evaluating a candidate service path vector. The method 1100 comprises identifying the complete solution provided by the candidate service path vector (e.g. the routing provided by the candidate service path vector; and the layer 1 and layer 3 network topology to support the routing provided by the candidate service path vector) and determining how well the solution provided by the candidate service path vector meets the set of constraints 416.

The method 1100 begins with blocks 1102, 1104 and 1106 in which the candidate evaluation module 414 identifies the complete solution provided by the candidate service path vector. In particular, at block 1102 the candidate evaluation module generates a layer 1 and layer 3 topology to support the routing identified in the candidate service path vector. Generating the topology may comprise identifying the layer 3 and layer 1 links to support the paths specified in the candidate service path vector.

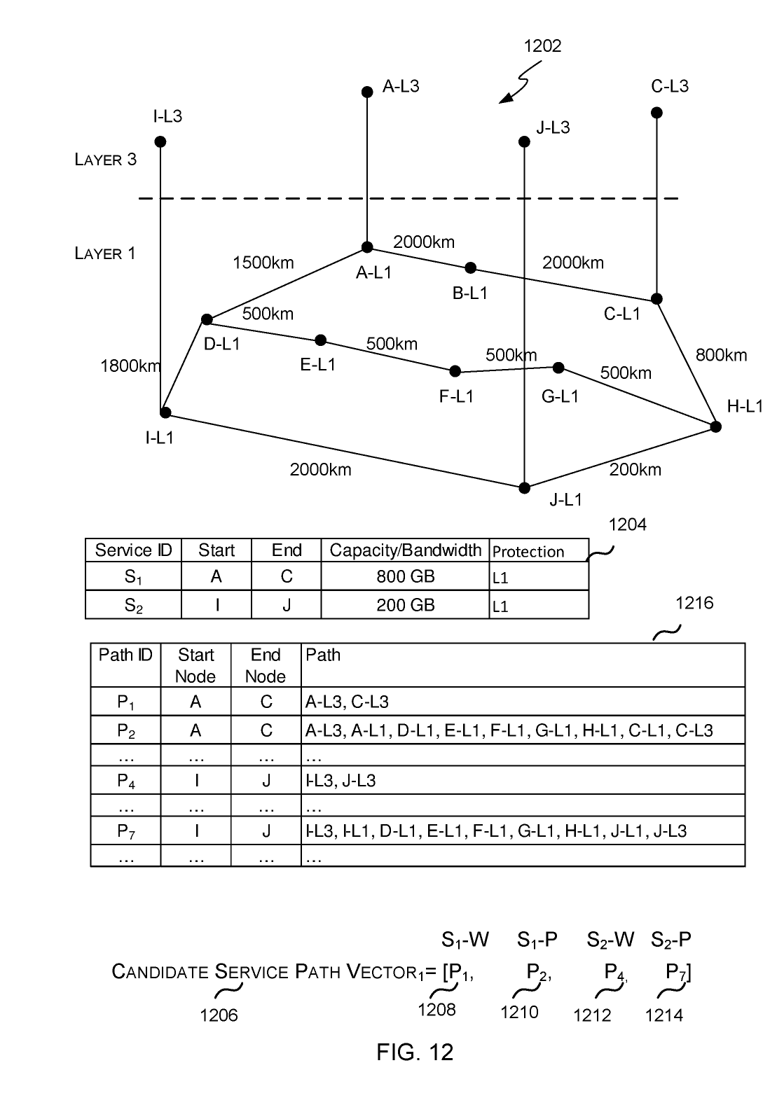

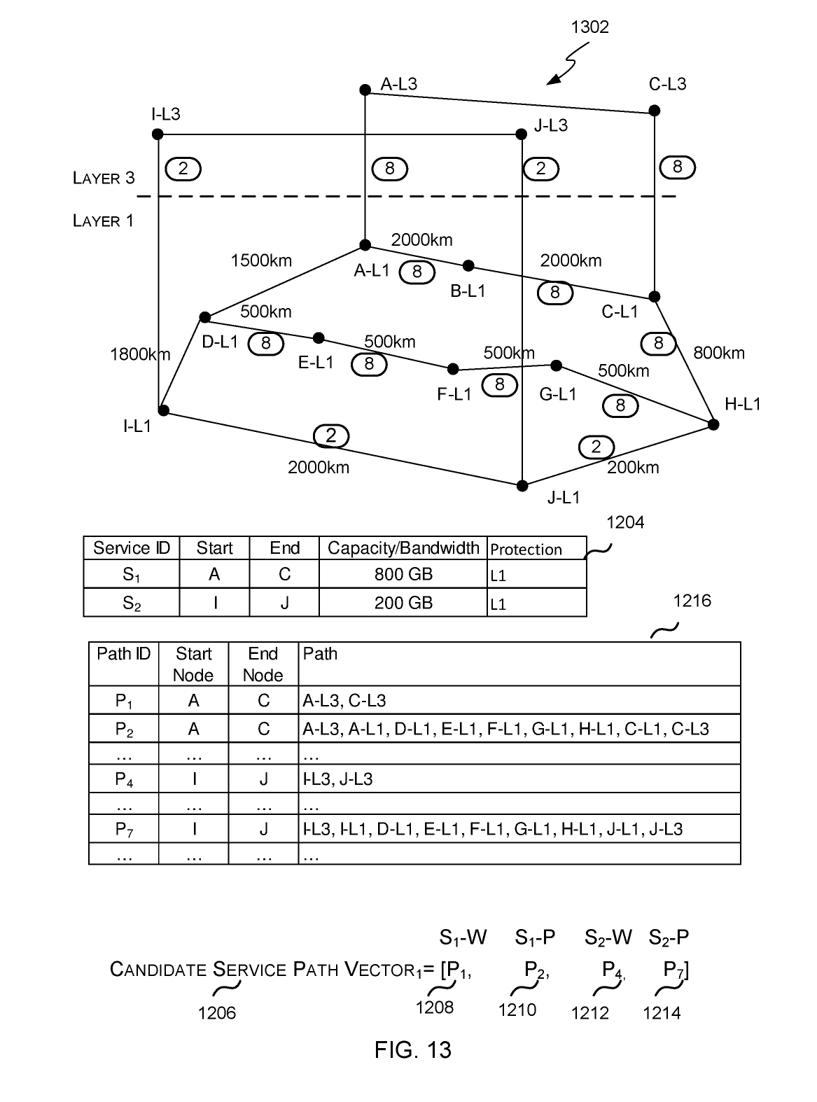

Reference is now made to FIGS. 12 and 13 which illustrate an example of generating the layer 3 and layer 1 topology to support the routing provided in a candidate service path vector. In the example of FIGS. 12 and 13, the set of network resources 1202 comprises ten layer 1 nodes (A-L1, B-L1, C-L1, D-L1, E-L1, F-L1, G-L1, H-L1, I-L1 and J-L1) and four layer 3 nodes (A-L3, C-L3, I-L3, and J-L3) interconnected as shown in FIG. 12; the demand matrix 1204 indicates there are two services S₁ and S₂ (both layer 1 protected) that run from A to C, and I to J respectively. The candidate service path vector 1206 being evaluated has four elements 1208, 1210, 1212 and 1214 which specify the S₁ working path, S₁ protection path, S₂ working path, and S₂ protection path respectively. From the path table 1216 it can be seen that the working path for S₁ is A-L3, C-L3, the protection path for S₁ is A-L3, A-L1, D-L1, E-L1, F-L1, G-L1, H-L1, C-L1, C-L3, the working path for S₂ is I-L3, J-L3 and the protection path for S₂ is I-L3, I-L1, D-L1, E-L1, F-L1, G-L1, H-L1, J-L1, J-L3.

To generate the layer 1 and layer 3 topology each path specified in the candidate service path vector 1206 is analyzed to ensure that there is a set of links that support that path and if not, one is created. For example the first path in the service path vector specifies a layer 3 link between A-L3 and C-L3. Since one does not already exist, it is created. A layer 3 link must be supported by a layer 1 path. In this case since there is a layer 1 path (e.g. A-L1, B-L1, C-L1) in the set of network resources 102 this does not need to be created. Similar analysis is repeated for each other path in the candidate service path vector 1206. Such analysis results in the multi-layer (layer 1 and layer 3) topology 1302 shown in FIG. 13.

Referring back to FIG. 11, once the multi-layer (layer 1 and layer 3) topology to support the routing provided in the candidate service path vector has been identified, the method 1100 proceeds to block 1104.

At block 1104, the candidate evaluation module 414 assigns capacity or bandwidth values to the links of the topology generated in block 1102 based on the requirements of the services in the demand matrix 408. In some examples, each link is assigned a bandwidth value that is equal to or greater than the sum of the requirement or bandwidth of each primary service for that link plus the maximum requirement or bandwidth of the secondary services for that link across the possible failure conditions specified (e.g. link, node or SRLG or SRG). A primary service for a link is a service in which the primary or working path traverses the link, and a secondary service for a link is a service in which the secondary or protection path traverses the link.

For example, referring back to FIG. 13, links A-L3, A-L1; A-L1, B-L1; B-L1; C-L1, C-L3 have only one primary service—S₁—thus the bandwidth of these links must greater than or equal to the bandwidth (800 Gbps) of S₁. This is indicated by the number 8 shown in a circle in FIG. 13. Similarly, links I-L3, I-L1; I-L1, J-L1; and J-L1, J-L3 have only one primary service—S₂—thus the bandwidth of these links must be greater than or equal to the bandwidth (200 Gbps) of S₂. This is indicated by the number 2 shown in a circle in FIG. 13.

Links A-L1, D-L1; and C-L1, H-L1 have only one secondary service—S₁—thus the bandwidth of these links must be greater than or equal to the bandwidth (800 Gbps) of S₁. Similarly, links I-L1, D-L1; and J-L1, H-L1 have only one secondary service—S₂—thus the bandwidth of these links must be greater than or equal to the bandwidth (200 Gbps) of S₂.

The remaining links -D-L1, E-L1; E-L1, F-L1; F-L1-G-L1; and G-L1, H-L1 each have two secondary services -S₁ and S₂. Since S₁ and S₂ are not indicated as being part of the same risk/failure group (e.g. shared risk group (SRG)) (and thus their primary or working routes are not likely to go down at the same time) then the bandwidth assigned to these links is greater than or equal to the maximum of either the S₁ or S₂ bandwidth—i.e. 800 Gbps.

It is noted that the actual bandwidth values assigned may be based on the information in the set of network resources 406. In particular, the set of network resources 406 may specify the incremental increases in bandwidth that can be made for any particular link. For example, the set of network resources 406 may specify that a particular link may only be increased by 10 Gbps or 100 Gbps increments. The set of network resources 406 may also specify a maximum utilization value for one or more of the links. For example, if a particular link is assigned a maximum utilization of 33.33% then a calculated utilization of 10 Gbps results in a bandwidth value of at least 30 Gbps being assigned to the link.

Referring back to FIG. 11, once the bandwidth values are assigned, in some cases the method 1100 proceeds to block 1106 and in other cases the method 1100 proceeds directly to block 1108. In particular, some layer 1 technologies such as optical fiber can only transmit information over a predetermined distance and thus to transmit information further that the predetermined distance the signal must be regenerated. In these cases the method 1100 may proceed to block 1106 where the location and number of any layer 1 regenerations for the topology generated at block 1102 are determined. However, where the layer 1 topology is not one that requires regeneration (e.g. a non-optical layer 1) or the topology does not comprise layer 1 then the method 1100 may proceed directly to block 1106.

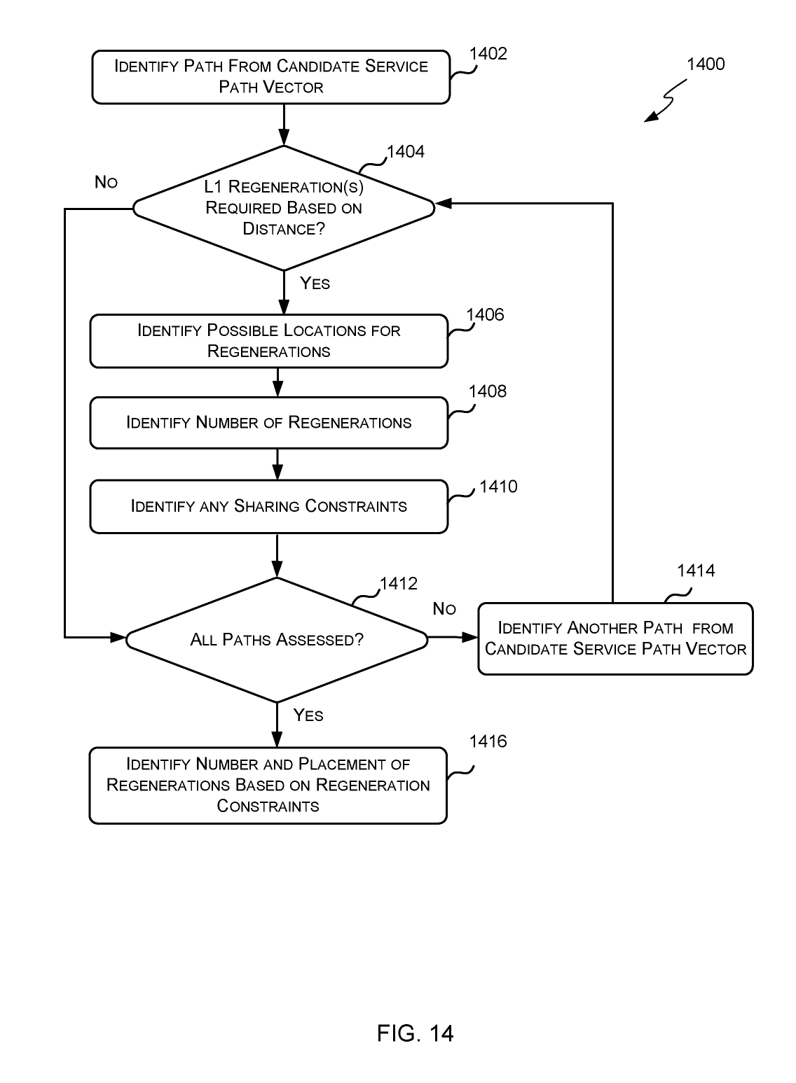

At block 1106 the candidate evaluation module 414 determines the location and number of any layer 1 regenerations. In some cases, determining the location and the number of the regenerations comprises evaluating the layer 1 paths to determine which exceed the predetermined distance and determining the best place for the regeneration(s). An example method for determining the location and number of any regenerations is described with reference to FIGS. 14-16. Once the number and location of the layer 1 regenerations have been determined the method proceeds to block 1108.

At bock 1108, the candidate evaluation module selects one of the constraints from the set of constraints 416. As described above, the set of constraints 416 outline the metrics for evaluating the candidate service path vectors. An example set of constraints will be described with reference to FIG. 17. Once a constraint has been selected the method 1100 proceeds to block 1110.

At block 1110, the candidate evaluation module generates a fitness value for the selected constraint (referred to herein as a sub-fitness value) that provides a quantitative measure of how well the solution provided by the candidate service path vector (e.g. routing and topology) meets the selected constraint.

The sub-fitness value is generated from a corresponding fitness function that assesses how well the network topology meets the selected constraint. Accordingly, if the constraints comprise a utilization constraint, delay constraint, speed constraint, efficiency constraint, and a disjointed constraint then there may be corresponding utilization, delay, speed, efficiency and disjointed fitness functions.

A disjointed fitness function determines whether the routes through the candidate network topology for disjointed services share any links and/or nodes. The disjointed fitness function may be configured so that any sharing of links and/or nodes between the routes of disjointed services results in a decrease in the fitness value for the candidate network topology.

Where the constraint is a hard constraint (e.g. a specific upper or lower limit is specified for the constraint) and the solution provided by the candidate service path vector does not meet the constraint, then a penalty may be assessed against the sub-fitness value. For example, the sub-fitness value may be adjusted based on the penalty value according to equation (1) shown below:

SubFitnessValue=SubFitnessValue*(Penalty^{Number of Failures}) (1)

where Penalty is a value between 0 and 1 and Number of Failures is the number of times the candidate network topology failed to meet the constraint. For example, if the hard constraint was a maximum number of adjacencies then each time the candidate network topology exceeded the maximum number of adjacencies then the Number of Failures is increased.

Once the fitness value for the selected constraint has been generated the method 1100 proceeds to block 1112 where it is determined whether a sub-fitness value has been generated for each constraint. If a sub-fitness value has not been generated for each constraint in the set of constraints then the method proceeds to block 1114 where another constraint is selected and the method is repeated until a sub-fitness value has been generated for each constraint and the method 1100 proceeds to block 1116.

At block 1116, the candidate evaluation module 414 combines the sub-fitness values (i.e. the fitness values for each constraint) to generate a final or overall fitness value for the candidate service path vector. For example, the fitness value may be calculated as the average of the sub-fitness value using equation (2) shown below:

$$FitnessValue = {\sum }_{x = 1}^{k} ( \frac{{SubFitnessValue}_{x}}{k} ) \qquad ( 2 )$$

where k is the number of constraints/service requirements.

As described above, not all constraints may be of equal importance and so in some cases the fitness value may be calculated from a weighted average of the sub-fitness values where the weights are assigned based on the relative importance of the corresponding constraint. For example, the sub-fitness value may be calculated using equation (3) shown below:

$$FitnessValue = {\sum }_{x = 1}^{k} ( \frac{{SubFitnessValue}_{x} * {Weight}_{x}}{k} ) \qquad ( 3 )$$

where k is the number of constraints/service requirements, and Weightₓ is the weight assigned to the X^{th} constraint.

Once the final or overall fitness value has been generated the method 1100 ends.

Reference is now made to FIG. 14 which illustrates a method 1400 which may be executed by the candidate evaluation module 414 to determine the location and number of layer 1 regenerations in the multi-layer topology determined, for example, according to step 1102 of FIG. 11.

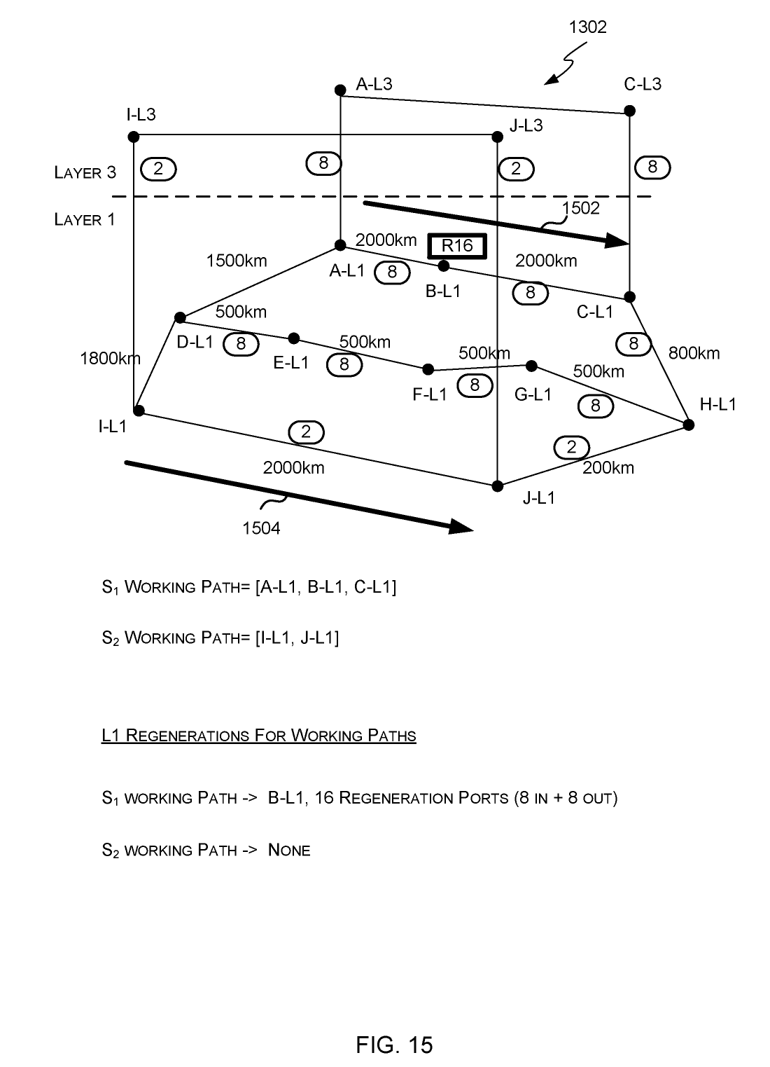

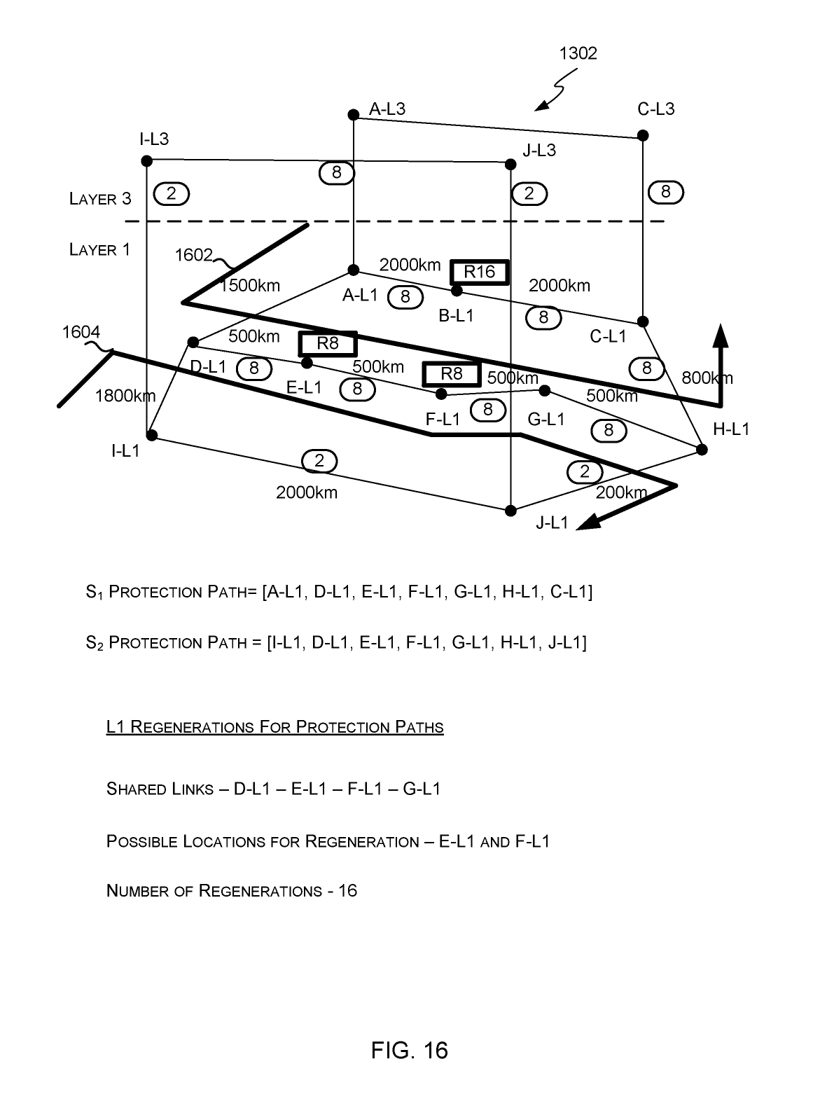

FIGS. 15 and 16 will be used to illustrate execution of the method 1400 to identify the regenerations for the working paths and protection paths respectively of a multi-layer topology. In the examples of FIGS. 15 and 16 the multi-layer topology is the topology 1302 of FIG. 13, the demand matrix is demand matrix 1204 of FIG. 12, the candidate service path vector is the first candidate service path vector 1206 of FIG. 12, and the path table path table is 1216 of FIG. 12.

The method 1400 begins at block 1402 where the candidate evaluation module 414 selects one of the paths in the candidate service path vector. In this example of FIGS. 15 and 16 there are four paths in the candidate service path vector 1206—primary or working paths for services S₁ and S₂ and secondary or protection paths for services S₁ and S₂. Accordingly, in the example of FIGS. 15 and 16 one of these four paths is selected in block 1402. Once a path from the candidate service path vector has been selected, the method 1400 proceeds to block 1404.

At block 1404, the candidate evaluation module 414 assesses the layer 1 links of the path selected in block 1402 to determine if any regenerations are required based on the total distance of the path and the predetermined distance of the layer 1 topology. In particular the candidate evaluation module 414 determines if the path of layer 1 links exceeds the predetermined distance.

In the examples of FIGS. 15 and 16 the predetermined distance is 2500 km. The S₁ working path 1502 of A-L1, B-L1 and C-L1 in FIG. 15 has a total distance of 4000 km (2000 km+2000 km) which is greater than the predetermined distance thus a layer 1 regeneration is required along this path. In contrast the S₂ working path 1504 of I-L1 and J-L1 of FIG. 15 has a total distance of 2000 km which is less than the predetermined distance and thus no layer 1 regeneration is required.

The total distance of the S₁ protection path 1602 in FIG. 16 is 4300 km (1500 km+500 km+500 km+500 km+500 km+800 km) which is greater than the predetermined distance thus a layer 1 regeneration is required along this path. Similarly the total distance of the S₂ protection path 1604 in FIG. 16 is 3000 km (1800 km+500 km+500 km+500 km+500 km+200 km) which is greater than the predetermined distance thus a layer 1 regeneration is required along this path.

If it is determined that a regeneration is required along the selected path the method 1400 proceeds to block 1406, otherwise the method proceeds directly to block 1412.

At block 1406, the candidate evaluation module 414 determines the possible locations for the regenerations based on the distance between nodes along the selected path. For example, there is only one node, B-L1, between the two end nodes A-L1 and C-L1 of the S₁ working path 1502 of FIG. 15 thus the regeneration can only be at node B-L1. In contrast, the regeneration for the S₁ protection path 1602 in FIG. 16 can be at E-L1 or F-L1 since the distance from these nodes to the respective end nodes (A-L1 and C-L1) is less than the predetermined distance. Similarly, the regeneration for the S₂ protection path 1604 in FIG. 16 could be at D-L1 or E-L1 since the distance from these nodes to the respective end nodes (I-L1 and J-L1) is less than the predetermined distance. Once the possible location of any regenerations has been identified the method 1400 proceeds to block 1408.

At block 1408, the candidate evaluation module 414 determines the number of regenerations required based on the bandwidth requirements of the service associated with the path. For example, if each regeneration port supports 100 Gbps, the number of regeneration ports for the S₁ working path 1502 of FIG. 15 is sixteen (8 in and 8 out). Similarly, the number of regeneration ports required for the S₁ protection path 1602 of FIG. 16 is also sixteen (8 in and 8 out). In contrast, the number of regeneration ports for the S₂ protection path 1604 of FIG. 16 is four (2 in and 2 out) since the bandwidth for S₂ is 200 Gbps. Once the number of regeneration ports required has been identified the method 1400 proceeds to block 1410.

At block 1410, the candidate evaluation module 414 identifies any sharing constraints. In particular, the candidate evaluation module 414 determines whether the regenerations ports for the selected paths can be shared with any other paths. In general a regeneration port can be shared between protection paths so long as the associated services for those protection paths do not have the same risk of failure (e.g. they do not belong to the same shared risk group (SRG)). For example, in FIG. 16 since the two services are not identified as being part of the same risk of failure (e.g. same SRG) then the regenerations for the two protection paths 1602 and 1604 can be shared. In general regenerations for primary or working paths cannot be shared. Once the sharing constraints have been identified the method proceeds to block 1412.

At block 1412, the candidate evaluation module 414 determines whether all paths in the candidate service path vector have been analyzed. If not all of the paths have been analyzed then the method 1400 proceeds to block 1414 where another path is selected from the candidate service path vector and the process repeats until all of the paths in the candidate service path vector have been analyzed. Once all of the paths have been analyzed, the method 1400 proceeds to block 1416.

At block 1416, the candidate evaluation module 414 takes all the information obtained from blocks 1404 to 1410 to identify the regeneration ports required on the paths and the placement thereof using one or more regeneration constraints. The regeneration constraints may specify preferences for the regeneration ports. Examples of regeneration constraints include, but are not limited to: that there is a preference that the regenerations be divided between nodes if possible, regeneration be split evenly between nodes, and that the regeneration ports are deployed in pairs.

For example, in FIG. 16 it is clear that the number of regeneration ports can be reduced if the regeneration ports for the S₁ and S₂ protection paths 1602 and 1604 are shared (which is possible since the corresponding services do not have the same risk of failure). The only node that satisfies the S₁ and S₂ protection path criteria is E-L1 accordingly at least 4 input ports need to be at E-L1. The only other constraint is that there must be at least sixteen regeneration ports between E-L1 and F-L1. Since the regenerations for the S₁ protection path 1602 can only be at either E-L1 or F-L1 and they must be in pairs (in this example) the possible division of regeneration nodes between E-L1 and F-L1 is as follows:

| E-L1 | F-L1 |
|---|---|
| 4 | 12 |
| 6 | 10 |
| 8 | 8 |
| 10 | 6 |
| 12 | 4 |
| 14 | 2 |
| 16 | 0 |

If the regeneration constraints specify that the regeneration ports can only be deployed in pairs and that an even split is preferred then 8 regeneration ports (4 in and 4 out) are deployed at E-L1 and 8 regeneration ports (4 in and 4 out) are deployed at F-L1 as shown in FIG. 16.

It will be evident to a person of skill in the art this is an example only and real-life situations have many more nodes and may have other regeneration criteria.

Once the protection path regeneration nodes have been identified then the method 1400 ends.

Reference is now made to FIG. 17 which illustrates an example set of constraints 416. As described above the set of constraints outline the metrics for evaluating the candidate service path vectors. For example, the set of constraints 416 of FIG. 17 include the following: adjacency limit; minimum routing cost; shortest path; shortest path with tolerance; delay limit; latency/jitter; optical signal to noise ratio (OSNR); optical distance; service protection; hops; differential delay; and disjointedness.

An adjacency limit constraint specifies that the number of adjacent nodes is to be limited. This limit may be required due to a hardware limit (e.g. maximum number of cards or node degree for optical networks) etc. A minimum routing cost constraint specifies that the minimum routed cost solution should be selected. A shortest (distance) path constraint specifies that the shorted distance path/route should be selecting when routing services. The user may be able to specify an acceptable tolerance limit so that the absolute shortest path/route does not always have to be taken, but a route that is within the tolerance of being the shortest path is acceptable. The delay limit constraint specifies the maximum amount of delay between transmission and receipt of service traffic. The latency/jitter constraint specifies that latency or jitter should be minimized.

The OSNR constraint specifies that OSNR should be optimized. The optical distance specifies that the maximum distance for optical links cannot be exceeded (otherwise the optical link will not work or needs to be regenerated incurring additional expense and network complexity). The service protection constraint specifies that there should be a backup route available in case the main route has a failure. This constraint can be specified for all or only some of the services. The hops constraint specifies that the number of hops between start and end nodes should be minimized. The differential delay constraint specifies that the difference in delay between two or more services should be minimized. The disjointedness constraint specifies that there should be no shared links, nodes and/or shared risk groups (SRGs) between one or more disjoint services.

The constraints may be classified as being either hard constraints or soft constraints. A hard constraint must be satisfied for the candidate network topology to be a viable solution. Accordingly a candidate service path vector that does not satisfy a hard constraint will have a poor fitness value. Hard constraints usually specify a particular threshold that has to be met. In the example set of constraints in FIG. 17, the adjacency limit, shortest path limit (without tolerance), delay limit, optical distance and service protection constraints are hard constraints. All the other constraints are soft constraints.

The hard constraints may be assigned a penalty value which is used in calculating the fitness value for when the constraint is not met. This is used to push the fitness value to a poorer or less favorable value when a candidate network topology does not meet a hard constraint.

It will be evident to a person of skill in the art that the constraints illustrated in FIG. 17 are examples only and any other routing, topology or other type of constraints (e.g. reduction in equipment required) may be used or specified.

Reference is now made to FIG. 18 which illustrates an example method 1800 for evolving the set of candidate service path vectors which may be executed by the candidate generation module 410, and the candidate evaluation module 414. The objective of the evolving is to increase the quality of the candidate service path vectors in the set.

The example method 1800 of FIG. 18 comprises identifying one or more parent candidate service path vectors in the set of candidate service path vectors, generating one or more child candidate service path vectors from the parent candidate service path vector(s), evaluating the child candidate service path vector(s), adding the child candidate service path vector(s) to the set of candidate service path vectors and selecting M candidate service path vectors from the combined set to continue. In some cases, the best M candidate service path vectors (e.g. based on the fitness values) are selected. In other cases M candidate service path vectors are selected randomly, and in yet other cases the best N candidate service path vectors are selected (e.g. based on the fitness values) and M-N random candidate service path vectors are selected.

The method 1800 starts at block 1802 where the candidate generation module 410 obtains the current set of candidate service path vectors 412. Once the current set of candidate service path vectors 412 has been obtained, the method 1800 proceeds to block 1804.

At block 1804, the candidate generation module 410 selects one or more parent candidate service path vectors from the set of candidate service path vectors 412. The parent candidate service path vector(s) may, for example, be selected based on their associated fitness value (e.g. the best candidate service path vector(s) based on fitness value may be selected as the parent(s)) or the parent candidate service path vector(s) may be selected using other criteria (e.g. the parent candidate service path vector(s) may be randomly selected or the parent candidate service path vector(s) may be selected based on a weighted random method). It will be evident to a person of skill in the art that there are many methods and/or criteria that can be used to select the parent candidate service path vector(s) Once the parent candidate service path vector(s) has/have been selected the method 1800 proceeds to block 1806.

At block 1806, the candidate generation module 410 generates one or more child candidate service path vectors from the parent candidate service path vector(s) selected in block 1804.

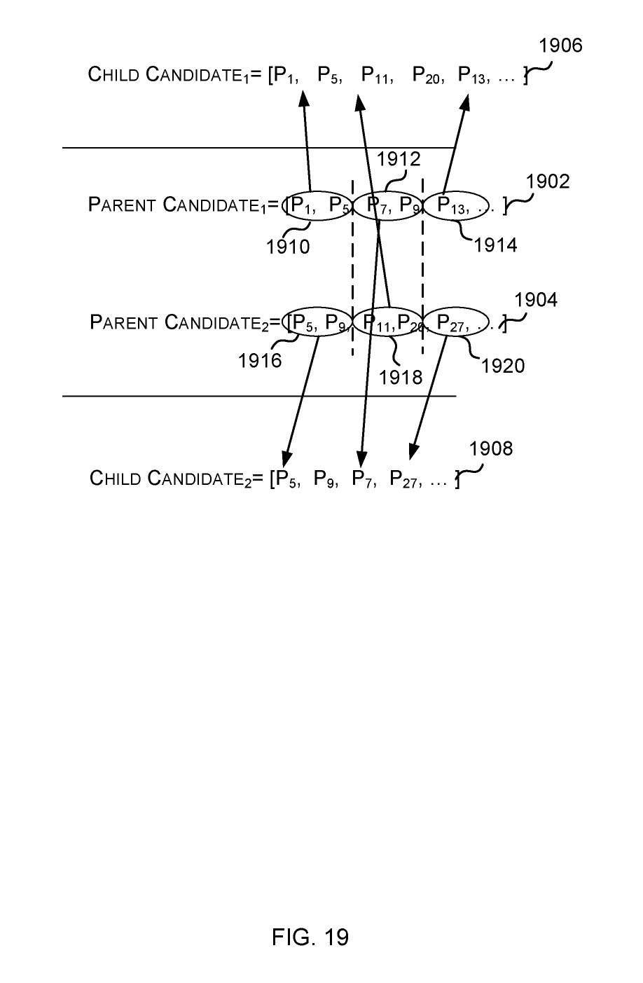

In some cases, where there are two or more parent candidate service path vectors, the child candidate service path vector(s) may be generated from the parent candidate service path vectors by mating or combining the parent candidate service path vectors using a known technique such as, but not limited to crossover. In some cases mating may comprise taking portions of multiple parent candidate service path vectors and combining them to form a new child candidate service path vector. An example of generating child candidate service path vectors by mating or combining parent candidate service path vectors will be described with reference to FIG. 19.

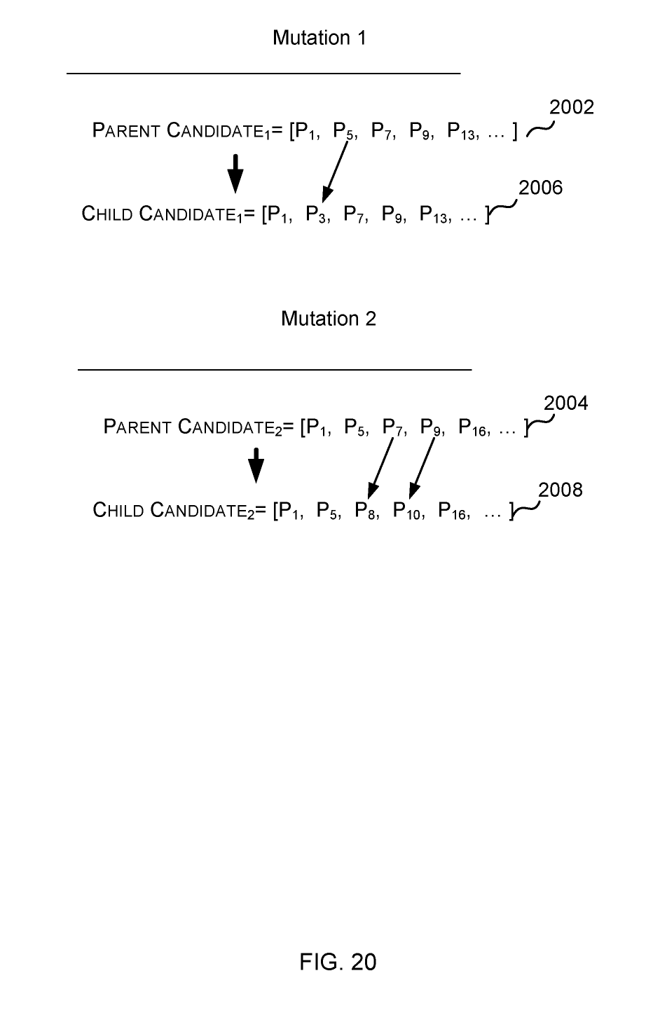

In other cases, the child candidate service path vector(s) may be generated by mutating the parent candidate service path vector(s). As is known to those of skill in the art, mutation involves altering a parent candidate service path vector. In some cases this may comprise randomly replacing one or more path IDs in the parent candidate service path vector with another valid path ID. For example, if the path ID for a particular service is selected for replacement then the path ID for that particular service is replaced with another valid path ID for that particular service (i.e. a path ID from the path table for the particular source and destination node pair). An example of generating child candidate service path vectors through mutation will be described with reference to FIG. 20.

In yet other cases, the child candidate service path vector(s) may be generated through both mutation and mating. For example, parent candidate service path vectors may be mated to produce one or more mated candidate service path vectors, the mated candidate service path vectors may then be mutated to form the child candidate service path vectors. Once the child candidate service path vector(s) has/have been generated the method 1800 proceeds to block 1808.

At block 1808, the child candidate service path vector(s) generated at block 1806 is/are evaluated (e.g. by the candidate evaluation module 414). In some cases evaluation comprises determining a fitness value, as described above, for each child candidate service path vector. Once the child candidate service path vector(s) has/have been evaluated, the method 1800 proceeds to block 1810.

At block 1810, the candidate generation module 410 adds the child candidate service path vector(s) to the set of candidate service path vectors. For example, if the set of candidate service path vectors obtained in block 1802 comprised fifty candidate service path vectors and two child candidate service path vectors are generated then the updated set of candidate service path vectors will comprise fifty-two candidate service path vectors. Once the child candidate service path vectors are added to the set of candidate service path vectors, the method 1800 proceeds to block 1812.

At block 1812, the candidate generation module 410 removes X candidate service path vectors from the combined set of candidate service path vectors where X is the number of child candidate service path vectors generated at block 1806. The X candidate service path vectors may be selected on the basis of being the “worst” or “weakest” candidate service path vectors or using other criteria, such a random selection criteria

In some cases selecting and removing the “worst” or “weakest” candidate service path vectors may comprise ranking the candidate service path vectors in the combined set based on their associated fitness value and removing the X candidate service path vectors with the worst (e.g. lowest) fitness values. In other cases, the candidate generation module 410 is configured to probabilistically remove the “worst” or “weakest” candidate service path vectors. In particular the candidate service path vectors with the worst (e.g. lowest) fitness values based on a removal probability which is proportional to their fitness value are removed from the set of candidate service path vectors. In either case, if the set of candidate service path vectors obtained in block 1802 comprised fifty candidate service path vectors, two child candidate service path vectors are generated and added to the set, the two worst (e.g. based on fitness values or removal probability) are removed from the set to bring the total number of candidate service path vectors in the set back to fifty.

If the X candidate service path vectors are selected based on random selection, then X random candidate service path vectors will be removed from the set. Optionally, the best N (where N is less than M) candidate service path vectors may be guaranteed to survive (i.e. remain in the set) and the random selection may only be based on the remainder.

It will be evident to a person of skill in the art that there are other methods that may be used to determine which candidate service path vectors survive to the next generation. Once X candidate service path vectors have been removed from the set, the method 1800 ends.

Reference is now made to FIG. 19 which illustrates an example of generating child candidate service path vectors by mating or combining parent candidate service path vectors. In the example, two parent candidate service path vectors 1902 and 1904 are selected from the set of candidate service path vectors 412. As described above the parent candidate service path vectors may be selected from the set of candidate service path vectors based on their quality (e.g. based on their fitness value) or they may be selected using other criteria or methods (e.g. they may be randomly selected).

Two child candidate service path vectors 1906 and 1908 are then generated by combining aspects (e.g. links) of the two parent candidate service path vectors 1902 and 1904 so that the child candidate service path vectors 1906 and 1908 comprise a combination path IDs from both parent candidate service path vectors 1902 and 1904. In particular, in the example shown in FIG. 19 each of the two parent candidate service path vectors 1902 and 1904 are divided into three parts 1910, 1912, 1914 and 1916, 1918, 1920. The first and third parts 1910 and 1914 of the first parent candidate service path vector 1902 are combined with the second part 1918 of the second parent candidate service path vector 1904 to form the first child candidate service path vector 1906. Then the second part 1912 of the first parent candidate service path vector 1902 is combined with the first and third parts 1916 and 1920 of the second parent candidate service path vector 1904 to form the second child candidate service path vector 1908. This technique is called crossover as different parts of a parent candidate service path vector are sent to different child candidate service path vectors.

Although FIG. 19 illustrates generating child candidate service path vectors by combining two parent candidate service path vectors, it will be evident to a person of skill in the art that the method could be similarly applied to generate child candidate service path vectors by combining more than two parent candidate service path vectors. Similarly, although FIG. 12 illustrates a two-point crossover, it will be evident to a person of skill in the art that any number of crossover points may be used.

Reference is now made to FIG. 20 which illustrates an example of generating child candidate service path vectors by mutating parent candidate service path vectors. In the example shown in FIG. 20 two parent candidate service path vectors 2002 and 2004 are selected from the set of candidate service path vectors 412. As described above the parent candidate service path vectors may be selected from the set of candidate service path vectors based on their quality (e.g. based on their fitness value) or they may be selected used another criteria or method (e.g. they may randomly selected).

Two child candidate service path vectors 2006 and 2008 are then created from a mutation of one of the parent candidate service path vectors 2002 and 2004. As described above mutation comprises altering the parent candidate service path vector in some manner. In the example shown in FIG. 20 the first child candidate service path vector 1306 is created from the first parent candidate service path vector through a mutation process that randomly replaces one or more path ID from the parent candidate service path vector with another valid path ID. For example, the first child candidate service path vector 2006 is generated by replacing the second path ID (P₅) in the first parent candidate service path vector 2002 with another valid path ID (P₃) for the corresponding service. Specifically, in this example P₅ and P₃ would be valid paths for the corresponding service. The other valid path ID may be randomly selected from the valid path IDs for the corresponding service (e.g. from the valid path IDs for the source and destination node pair of the service). Other mutation methods may randomly replace more than one path ID and/or the number of path IDs replaced may be randomly selected.

In the example shown in FIG. 20, the second child candidate service path vector 2008 is created from the second parent candidate service path vector 2004 through a mutation process that replaces two path IDs in the parent candidate service path vector 2004.

In particular, the third and fourth path links (F₇, P₉) of the second parent candidate service path vector 2004 are both replaced with other valid path IDs (P₉, P₁₀) for the corresponding service.

It will be evident to a person of skill in the art that FIG. 20 illustrates example mutation techniques and other known mutation techniques may also be used. For example, other mutation techniques may use heuristics to mutate a parent candidate service path vector to generate one or more child candidate service path vectors.

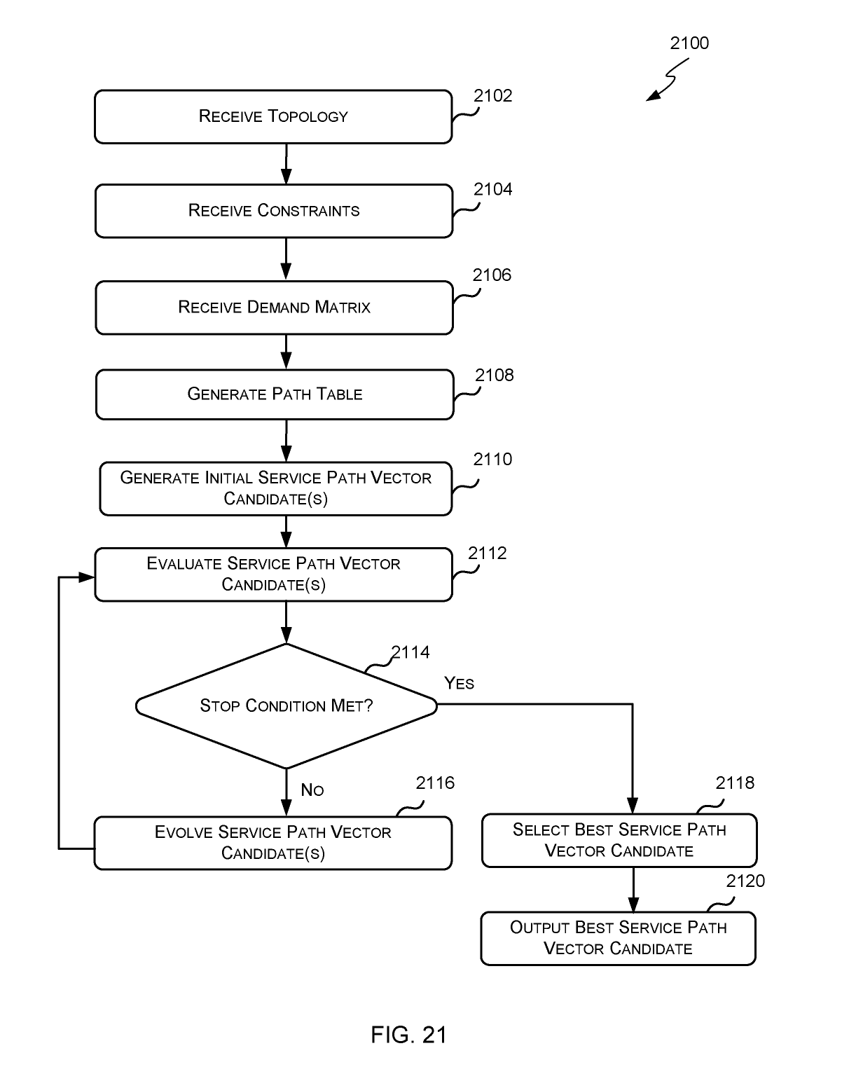

Although the systems and methods described above have been described as being configured to specifically identify the optimum multi-layer topology to support a set of service requirements, many of the described methods and techniques may also be used to determine the optimum routing of a set of services through a fixed single-layer or multi-layer network topology. By way of example, reference is now made to FIG. 21 which illustrates an example method 2100 which uses the methods and techniques described above to determine the optimum routing of a set of services over a fixed or known single-layer or multi-layer network topology by generating and evaluating candidate service path vectors.

The method 2100 begins at block 2102 where the network topology is received. The network topology may comprise, for example, the nodes of the network, the capability of the nodes (e.g. layer 1 or layer 3), the links between the nodes (inter-layer links and intra-layer links (where the network is multi-layer)), and the bandwidth or capacity of the links. It will be evident to a person of skill in the art that these are examples only and the network topology may comprise additional, fewer or different items. Once the network topology has been received the method 2100 proceeds to block 2104.

At block 2104, a set of constraints (e.g. constraints 416 of FIG. 17) is received. As described above the set of constraints includes a list of features (referred to as a constraint) that the candidate service path vectors are evaluated against. The set of constraints may be determined by the user/owner of the network based on the way in which they wish to optimize the routing of services. For example, one user may wish to generate the routing that provides the lowest latency; and another user may wish to achieve the routing with a minimum number of hops.

As described above, the constraints may be classified as being either hard constraints or soft constraints. Also, not all constraints may be of equal importance, so in some cases the set of constraints may comprise, in addition to a listing of the constraints themselves, weights indicating the relative importance of the constraints. Once the set of constraints have been received the method 2100 proceeds to block 2106.

At block 2106, a demand matrix, such as demand matrix 200 described above, is received. As described above, the demand matrix provides a list of services to be routed through the network and the requirements of each service. A service represents traffic that is sent from one node (e.g. the start or source node) in a network to another (e.g. the end or destination node). The requirement/demand of a service is the amount of traffic that is sent from the start node to the end node. Each service may also be associated with one or more constraints. Once the demand matrix has been received the method 2100 proceeds to block 2108.

At block 2108, a path table is generated from the network topology and the demand matrix. As described above the path table provides a list of the valid routes between each pair of source and destination nodes in the received demand matrix. The path table may be generated generally in accordance with the method 600 described above with reference to FIGS. 6 to 8. Where, however, the network only comprises a single layer (e.g. layer 3) or where only a single layer (e.g. layer 3) is being analyzed only single layer routes may be identified and analyzed (i.e. compared to the path criteria). Also, since the topology is known the initial step of generating a superset layer 3 topology can be skipped. Once the path table has been generated the method 2100 proceeds to block 2110.

At block 2110, one or more candidate service path vectors are generated from the path table and the demand matrix. As described above, each candidate service path vector comprises an indexed list of path IDs from the path table which identify a path/route for each service and each protected service in the demand matrix. In particular, where a service is protected then there will be two path IDs in each candidate service path vector for that service, one for the working or primary path and one for the secondary or protection path. The initial candidate service path vector(s) may be generated in accordance with the method 900 described above with reference to FIGS. 9 and 10. For example, each candidate service path vector may be generated by randomly selecting, for each service, one of the paths in the path table to get from the service source node to the service destination node. Once the initial set of candidate service path vectors has been generated the method 2100 proceeds to block 2112.

At block 2112, each candidate service path vector is evaluated against the received set of constraints. Evaluation of a candidate service path vector may comprise generating a fitness value that is a quantitative measure of how well the routing provided by the candidate service path vector meets the received set of constraints. Since the topology is known the evaluation step described above of generating the topology to support the routing provided by the candidate service path vector is not completed.

The fitness values for the candidate service path vectors may be generated as described above with reference to FIG. 4. For example, generating a fitness value may comprise determining a sub-fitness value for each constraint where the sub-fitness value is a quantitative measure of how well the candidate service path vector meets the specific constraint and combining (e.g. summing or averaging) the sub-fitness values to generate the fitness value. As noted above, in some cases all constraints may not be of equal importance so the final fitness value may be a weighted combination (e.g. sum or average) of sub-fitness values where the weights assigned to different sub-fitness values indicate the relative importance of their corresponding constraint. In some cases the fitness value is a number between 0 and 1 where 1 indicates an optimum candidate and 0 indicates a very poor candidate. Once the set of candidate service path vectors have been evaluated, the method 2100 proceeds to block 2114.

At block 2114, it is determined whether at least one stop condition has been met. The stop condition(s) may be, for example, if the best fitness value in the set of fitness values has not improved or changed after a predetermined number, R, of iterations. It will be evident to a person of skill in the art that this is an example only and other stop conditions may be used. If it is determined that none of the stop conditions have been met then the method 2100 proceeds to block 2116. If, however, it is determined that at least one stop condition has been met then the method 2100 proceeds to block 2118.

At block 2116, the set of candidate service path vectors are evolved in an attempt to increase the quality of the candidate service path vectors in the set. In some cases evolving the set of candidate service path vectors comprises selecting one or more of the candidate service path vectors from the set of candidate service path vectors, generating one or more new candidate service path vectors from the selected candidate service path vectors (e.g. via mutation, mating (e.g. crossover) and/or a combination thereof) and replacing some of the candidate service path vectors in the set with the new candidate service path vectors. In some cases the new candidate service path vectors only replace candidate service path vectors in the set if the new candidate service path vectors are better (e.g. based on fitness value) than candidate service path vectors in the set. In other cases the worst candidate (e.g. based on fitness value) is retained in the set of candidate service path vectors to preserve diversity. Deciding to retain the worse candidate service path vector is driven by a probability determined by the fitness of the candidate. In yet other cases the candidate service path vectors that are replaced by the new candidate service path vectors may be randomly selected from the set of candidate service path vectors.

For example, the new candidate service path vectors may be generated through mating and/or mutation as described above with reference to FIGS. 19 and 20. Once the new candidate service path vector(s) has/have been generated the method 2100 then proceeds back to block 2112 where the new candidate service path vectors are evaluated. The set of candidate service path vectors is then updated to include M candidate service path vectors where M is the number of candidate service path vectors initially generated in block 2110. In some cases the best M candidate service path vectors (e.g. based on the fitness values) are selected. In other cases M candidate service path vectors are randomly selected. This process of evolving the set of candidate service path vectors is repeated until a stop condition is satisfied in block 2114.

At block 2118, once a stop condition has been met, the best candidate service path vector (e.g. the candidate service path vector with the best fitness value) is selected and output (block 2120).

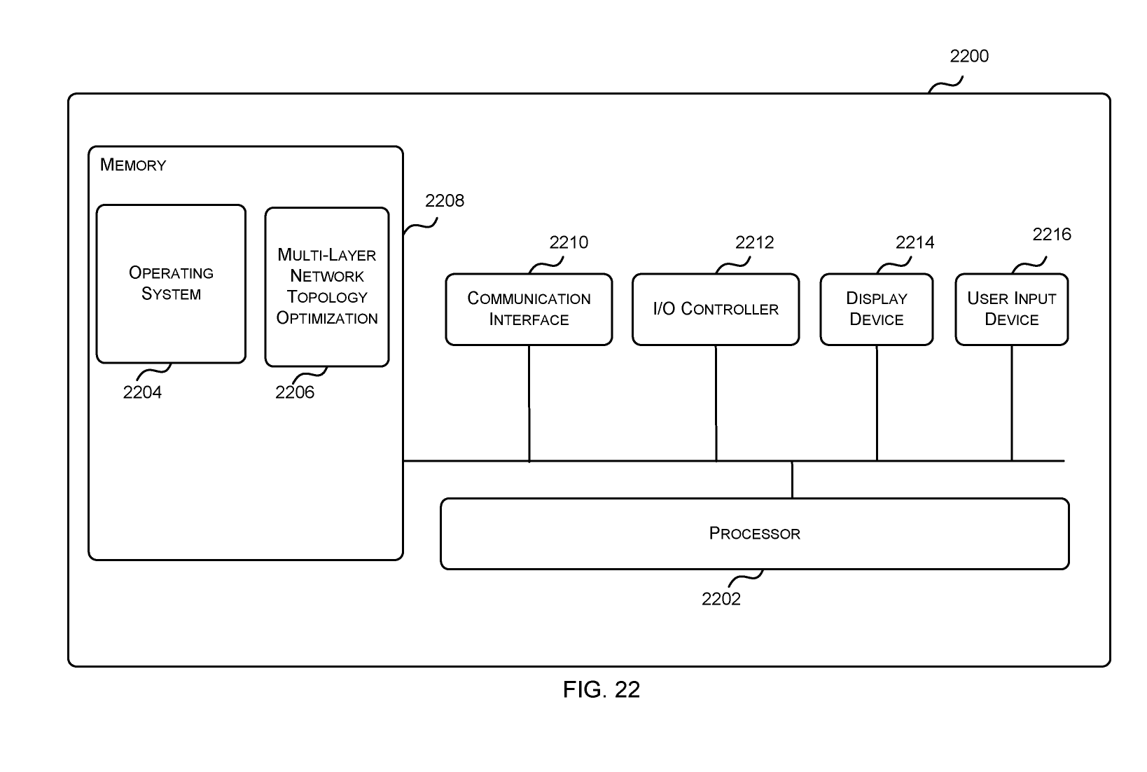

Reference is now made to FIG. 22 which illustrates various components of an exemplary computing-based device 2200 which may be implemented as any form of a computing and/or electronic device, and in which embodiments of the methods and systems described herein may be implemented.

Computing-based device 2200 comprises one or more processors 2202 which may be microprocessors, controllers or any other suitable type of processors for processing computer executable instructions to control the operation of the device in order to perform multi-layer network topology optimization. In some examples, for example where a system on a chip architecture is used, the processors 2202 may include one or more fixed function blocks (also referred to as accelerators) which implement a part of the method of performing multi-layer network topology optimization in hardware (rather than software or firmware). Platform software comprising an operating system 2204 or any other suitable platform software may be provided at the computing-based device to enable application software, such as a multi-layer network topology optimization module 2206 to be executed on the device.

The computer executable instructions may be provided using any computer-readable media that is accessible by computing based device 2200. Computer-readable media may include, for example, computer storage media such as memory 2208 and communications media. Computer storage media (i.e. non-transitory machine readable media), such as memory 2208, includes volatile and non-volatile, removable and non-removable media implemented in any method or technology for storage of information such as computer readable instructions, data structures, program modules or other data. Computer storage media includes, but is not limited to, RAM, ROM, EPROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing device. In contrast, communication media may embody computer readable instructions, data structures, program modules, or other data in a modulated data signal, such as a carrier wave, or other transport mechanism. As defined herein, computer storage media does not include communication media. Although the computer storage media (i.e. non-transitory machine readable media, e.g. memory 2208) is shown within the computing-based device 2200 it will be appreciated that the storage may be distributed or located remotely and accessed via a network or other communication link (e.g. using communication interface 2210).

The computing-based device 2200 also comprises an input/output controller 2212 arranged to output display information to a display device 2214 which may be separate from or integral to the computing-based device 2200. The display information may provide a graphical user interface. The input/output controller 2212 is also arranged to receive and process input from one or more devices, such as a user input device 2216 (e.g. a mouse or a keyboard). In an embodiment the display device 2214 may also act as the user input device 2216 if it is a touch sensitive display device. The input/output controller 2212 may also output data to devices other than the display device, e.g. a locally connected printing device (not shown in FIG. 22).

The term ‘processor’ and ‘computer’ are used herein to refer to any device, or portion thereof, with processing capability such that it can execute instructions. The term ‘processor’ may, for example, include central processing units (CPUs), graphics processing units (GPUs or VPUs), physics processing units (PPUs), radio processing units (RPUs), digital signal processors (DSPs), general purpose processors (e.g. a general purpose GPU), microprocessors, any processing unit which is designed to accelerate tasks outside of a CPU, etc. Those skilled in the art will realize that such processing capabilities are incorporated into many different devices and therefore the term ‘computer’ includes set top boxes, media players, digital radios, PCs, servers, mobile telephones, personal digital assistants and many other devices.

Those skilled in the art will realize that storage devices utilized to store program instructions can be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a DSP, programmable logic array, or the like.

The methods described herein may be performed by a computer configured with software in machine readable form stored on a tangible storage medium e.g. in the form of a computer program comprising computer readable program code for configuring a computer to perform the constituent portions of described methods or in the form of a computer program comprising computer program code means adapted to perform all the steps of any of the methods described herein when the program is run on a computer and where the computer program may be embodied on a computer readable storage medium. Examples of tangible (or non-transitory) storage media include disks, thumb drives, memory cards etc. and do not include propagated signals. The software can be suitable for execution on a parallel processor or a serial processor such that the method steps may be carried out in any suitable order, or simultaneously.

The hardware components described herein may be generated by a non-transitory computer readable storage medium having encoded thereon computer readable program code.

It is also intended to encompass software which “describes” or defines the configuration of hardware that implements a module, functionality, component or logic described above, such as HDL (hardware description language) software, as is used for designing integrated circuits, or for configuring programmable chips, to carry out desired functions. That is, there may be provided a computer readable storage medium having encoded thereon computer readable program code for generating a processing unit configured to perform any of the methods described herein, or for generating a processing unit comprising any apparatus described herein. That is, a computer system may be configured to generate a representation of a digital circuit from definitions of circuit elements and data defining rules for combining those circuit elements, wherein a non-transitory computer readable storage medium may have stored thereon processor executable instructions that when executed at such a computer system, cause the computer system to generate a processing unit as described herein.

Memories storing machine executable data for use in implementing disclosed aspects can be non-transitory media. Non-transitory media can be volatile or non-volatile. Examples of volatile non-transitory media include semiconductor-based memory, such as SRAM or DRAM. Examples of technologies that can be used to implement non-volatile memory include optical and magnetic memory technologies, flash memory, phase change memory, resistive RAM.

A particular reference to “logic” refers to structure that performs a function or functions. An example of logic includes circuitry that is arranged to perform those function(s). For example, such circuitry may include transistors and/or other hardware elements available in a manufacturing process. Such transistors and/or other elements may be used to form circuitry or structures that implement and/or contain memory, such as registers, flip flops, or latches, logical operators, such as Boolean operations, mathematical operators, such as adders, multipliers, or shifters, and interconnect, by way of example. Such elements may be provided as custom circuits or standard cell libraries, macros, or at other levels of abstraction. Such elements may be interconnected in a specific arrangement. Logic may include circuitry that is fixed function and circuitry can be programmed to perform a function or functions; such programming may be provided from a firmware or software update or control mechanism. Logic identified to perform one function may also include logic that implements a constituent function or sub-process. In an example, hardware logic has circuitry that implements a fixed function operation, or operations, state machine or process.

Any range or device value given herein may be extended or altered without losing the effect sought, as will be apparent to the skilled person.

It will be understood that the benefits and advantages described above may relate to one embodiment or may relate to several embodiments. The embodiments are not limited to those that solve any or all of the stated problems or those that have any or all of the stated benefits and advantages.

Any reference to ‘an’ item refers to one or more of those items. The term ‘comprising’ is used herein to mean including the method blocks or elements identified, but that such blocks or elements do not comprise an exclusive list and an apparatus may contain additional blocks or elements and a method may contain additional operations or elements. Furthermore, the blocks, elements and operations are themselves not impliedly closed.

The steps of the methods described herein may be carried out in any suitable order, or simultaneously where appropriate. The arrows between boxes in the figures show one example sequence of method steps but are not intended to exclude other sequences or the performance of multiple steps in parallel. Additionally, individual blocks may be deleted from any of the methods without departing from the spirit and scope of the subject matter described herein. Aspects of any of the examples described above may be combined with aspects of any of the other examples described to form further examples without losing the effect sought. Where elements of the figures are shown connected by arrows, it will be appreciated that these arrows show just one example flow of communications (including data and control messages) between elements. The flow between elements may be in either direction or in both directions.

It will be understood that the above description of a preferred embodiment is given by way of example only and that various modifications may be made by those skilled in the art. Although various embodiments have been described above with a certain degree of particularity, or with reference to one or more individual embodiments, those skilled in the art could make numerous alterations to the disclosed embodiments without departing from the spirit or scope of this invention.

1-32. (canceled)

33. A computer-implemented method of generating an optimized multi-layer network topology for a set of services, the method comprising, in a processing module:
generating one or more candidate service path vectors, each candidate service path vector providing at least one single or multi-layer path for each service of the set of services;
evaluating each of the candidate service path vectors comprising:
identifying, for each candidate service path vector, a multi-layer topology from a set of network resources to support the paths provided in that candidate service path vector;
generating, for each candidate service path vector, a fitness value, the fitness value indicating how well the candidate service path vector and the identified multi-layer topology for that candidate service path vector meet one or more constraints;
determining whether a stopping condition is met based on the fitness values;
in response to determining a stopping condition is not met, repeating the evaluating and determining; and
in response to determining a stopping condition is met, outputting one of the candidate service path vectors and the identified multi-layer topology for that candidate service path vector.

34. The method of claim 33, wherein each candidate service path vector comprises a plurality of ordered elements, each element comprising a path identifier for a service of the set of services, each path identifier indicating a single layer or multi-layer path from a source node to a destination node of the corresponding service.

35. The method of claim 34, wherein each path identifier provides a link to an entry in a path table that sets out a single layer or multi-layer path from a source node to a destination node, and optionally, further comprising: generating the path table from the set of services and the set of network resources, and optionally, wherein generating the path table from the set of services and the set of network resources comprises: identifying from the set of network resources each viable single layer and multi-layer path between each source and destination node pair in the set of services; and storing each viable single layer and multi-layer path in the path table in association with a unique path identifier, and optionally, wherein a viable path is a path that meets one or more path criteria.

36. The method of claim 35, wherein generating a candidate service path vector comprises, for each service, selecting at least one path identifier from the path table for a path between a source and destination node of the service, and inserting the selected path identifier in an element of the candidate service path vector associated with the service, and/or optionally, wherein at least one of the services in the set of services is a protected service, and generating a candidate service path vector comprises:
for each service, selecting a path identifier from the path table for a path between a source and destination node of the service;
for each protected service, selecting a second path identifier from the path table for a path between the source and destination node of the service; and
storing each of the selected path identifiers in an element of the candidate service path vector corresponding to the associated service.

37. The method of claim 33, wherein identifying a multi-layer topology for a candidate service path vector comprises identifying a network of inter-layer and intra-layer links to support the paths provided by the candidate service path vector.

38. The method of claim 37, wherein identifying a multi-layer topology for a candidate service path vector further comprises determining a bandwidth of each intra-layer link based on demands associated with the set of services.

39. The method of claim 37, wherein one of the multi-layers is a physical layer and identifying a multi-layer topology for a candidate service path vector further comprises determining a placement and a number of physical layer regenerations to support the paths provided by the candidate service path vector, and optionally, wherein determining the placement and number of physical layer regenerations to support the paths provided by the candidate service path vector comprises, for each path provided by the candidate service path vector:
determining whether any regeneration is required for the path based on a distance of the path;
in response to determining regeneration is required, identifying possible locations for the regeneration;
identifying a number of regenerations based on a demand of the service associated with the path;
identifying any sharing constraints; and
determining the placement and number of physical layer regenerations based on the identified possible locations, identified number of regenerations, and sharing constraints.

40. A system to determine an optimized multi-layer network topology for a set of services, the system comprising:
a candidate generation module configured to generate one or more candidate service path vectors, each candidate service path vector providing at least one single or multi-layer path for each service of the set of services;
a candidate evaluation module configured to repeatedly evaluate each of the candidate service path vectors by:
identifying, for each candidate service path vector, a multi-layer topology from a set of network resources to support the paths provided in that candidate service path vector;
generating, for each candidate service path vector, a fitness value, the fitness value indicating how well the candidate service path vector and the identified multi-layer topology for that candidate service path vector meet one or more constraints; and
a stop condition module configured to repeatedly determine whether a stopping condition is met based on the fitness values and in response to determining a stopping condition is met, output one of the candidate service path vectors and the identified multi-layer topology for that candidate service path vector.

41. The system of claim 40, wherein each candidate service path vector comprises a plurality of ordered elements, each element comprising a path identifier for a service of the set of services, each path identifier indicating a single layer or multi-layer path from a source node to a destination node of the corresponding service.

42. The system of claim 41, wherein each path identifier provides a link to an entry in a path table that sets out a single layer or multi-layer path from a source node to a destination node.

43. The system of claim 42, further comprising: a path generation module configured to generate the path table from the set of services and the set of network resources, and optionally, wherein the path generation module is configured to generate the path table from the set of services and the set of network resources by: identifying from the set of network resources each viable single layer and multi-layer path between each source and destination node pair in the set of services; and storing each viable single layer and multi-layer path in the path table in association with a unique path identifier, or optionally, wherein a viable path is a path that meets one or more path criteria.

44. The system of claim 42, wherein the candidate generation module is configured to generate a candidate service path vector by, for each service, selecting at least one path identifier from the path table for a path between a source and destination node of the service, and inserting the selected path identifier in an element of the candidate service path vector associated with the service.

45. The system of claim 42, wherein at least one of the services in the set of services is a protected service, and the candidate generation module is configured to generate a candidate service path vector by:
for each service, selecting a path identifier from the path table for a path between a source and destination node of the service;
for each protected service, selecting a second path identifier from the path table for a path between the source and destination node of the service; and
storing each of the selected path identifiers in an element of the candidate service path vector corresponding to the associated service.

46. The system of claim 40, wherein the candidate evaluation module is configured to identify a multi-layer topology for a candidate service path vector by identifying a network of inter-layer and intra-layer links to support the paths provided by the candidate service path vector.

47. The system of claim 46, wherein the candidate evaluation module is further configured to identify a multi-layer topology for a candidate service path vector by determining a bandwidth of each intra-layer link based on demands associated with the set of services.

48. The system of claim 46, wherein one of the multi-layers is a physical layer and the candidate evaluation module is further configured to identify a multi-layer topology for a candidate service path vector by determining a placement and a number of physical layer regenerations to support the paths provided by the candidate service path vector, and optionally, wherein the candidate evaluation module is configured to determine the placement and number of physical regenerations to support the paths provided by the candidate service path vector by, for each path provided by the candidate service path vector:
determining whether any regeneration is required for the path based on a distance of the path;
in response to determining regeneration is required, identifying possible locations for the regeneration;
identifying a number of regenerations based on a demand of the service associated with the path; and
identifying any sharing constraints; and
determining the placement and number of physical layer regenerations based on the identified possible locations, identified number of regenerations, and sharing constraints.

49. A computer-implemented method of determining an optimized routing of a set of services through a network topology, the method comprising, in a processing module:
generating one or more candidate service path vectors, each candidate service path vector providing at least one path through the network topology for each service of a plurality of services;
evaluating each of the candidate service path vectors comprising generating, for each candidate service path vector, a fitness value, the fitness value indicating how well the candidate service path vector meets one or more constraints;
determining whether a stopping condition is met based on the fitness values;
in response to determining a stopping condition is not met, repeating the evaluating and determining; and
in response to determining a stopping condition is met, outputting one of the candidate service path vectors.

50. The method of claim 49, wherein each candidate service path vector comprises a plurality of ordered elements, each element comprising a path identifier for a service of the set of services, each path identifier indicating a path from a source node to a destination node of the corresponding service, and optionally, wherein each path identifier provides a link to an entry in a path table that sets out a path from a source node to a destination node.

51. The method of claim 50, further comprising: generating the path table from the set of services and the network topology, and optionally, wherein generating the path table from the set of services and the network topology comprises: identifying each viable path through the network topology between each source and destination node pair in the set of services; and storing each viable path in the path table in association with a unique path identifier, and optionally, wherein a viable path is a path that meets one or more path criteria.

52. The method of claim 51, wherein generating a candidate service path vector comprises, for each service, selecting at least one path identifier from the path table for a path between a source and destination node of the service, and inserting the selected path identifier in an element of the candidate service path vector associated with the service, or optionally, wherein at least one of the services in the set of services is a protected service, and generating a candidate service path vector comprises:
for each service, selecting a path identifier from the path table for a path between a source and destination node of the service;
for each protected service, selecting a second path identifier from the path table for a path between the source and destination node of the service; and
storing each of the selected path identifiers in a separate element of the candidate service path vector corresponding to the associated service.
